(19) United States
(12) Patent Application Publication
(10) Pub. No.: US 2025/0001636 A1
(43) Pub. Date: Jan. 2, 2025

(54) APPARATUS AND METHOD FOR CARRYING OUT CUTTING OPERATIONS ON FORMAT EDGES OF AT LEAST ONE PRINTED PRODUCT CONFIGURED WITH A JAW FOLD OR COVER

(71) Applicant: Mueller Martini Holding AG, Hergiswil (CH)

(72) Inventors: Mathias Bucher, Adligenswil (CH); Reto Peyer, Boningen (CH)

(21) Appl. No.: 18/754,230

(22) Filed: Jun. 26, 2024

(30) Foreign Application Priority Data
Jun. 29, 2023 (DE) 10 2023 117 233.6

(51) Int. Cl. B26D 7/01; B26D 7/00; B26D 7/02; B26D 7/06

(52) U.S. Cl. CPC B26D 7/015; B26D 7/025; B26D 7/0633; B26D 7/0675; B26D 2007/0068

(57) ABSTRACT

In an apparatus for performing cutting operations on at least one open format edge of at least one printed product, a cutting station operable for carrying out the front cut is provided with an intermediate station on the input side. The intermediate station is equipped with elements for creating a spread of a jaw fold belonging to the printed product or of a cover belonging to the printed product. The first element has a configuration which, in operative connection with a translation of the printed product, initiates the spreading of a jaw fold or of a cover and consolidates the opening thereof. The second element has a configuration that allows the printed product to be transported, with the jaw fold or cover spread, via a further translation to the front cut location.

### CROSS REFERENCE TO RELATED APPLICATIONS

This application claims benefit to German Patent Application No. DE 10 2023 117 233.6, filed on Jun. 29, 2023, which is hereby incorporated by reference herein.

### FIELD

The present disclosure relates to an apparatus for carrying out cutting operations on open format edges of at least one printed product, specifically for trimming at least one head edge, front edge or foot edge according to the explanations in this disclosure and according to various approaches of the state of the art.

### BACKGROUND

The term “open format edges” is understood to refer to head parts, front parts, and foot parts (also called head edge, front edge, foot edge) of the printed product, regardless of whether the printed product is composed of individual pages or signatures, and also regardless of how the final configuration of the books was performed.

To industrially produce printed products (here also referred to as blocks or booklets) in small or very small print runs, down to one piece, so-called “three-knife trimmers” are used, which are capable of trimming products having the same or variable formats and thicknesses to the desired formats, one after the other, with high cycle output and an extremely high cut quality and without interruption in the production process.

In a cutting apparatus having three cutting stations, the printed products, i.e., generally book blocks or booklets of a predetermined thickness, are cut to the final format at the head edge, foot edge, and front edge. The printed products are bound at the spine to form a unit in accordance with the intended purpose thereof. Any known operating method may be considered for the binding, for example thread-stitching, perfect binding, gathering-stitching, etc.

Such a three-knife trimmer of the newer generation can be used both as a solo machine and in line with other production equipment or production lines, respectively. A perfect binder can be mentioned here as one of many examples.

The purpose of the apparatus, hereinafter also called “three-knife trimmer,” is to trim the provided printed products, i.e., mostly book blocks and/or booklets, generally also referred to as printed products, at the three open edges. This is accomplished by the book block or the booklet being clamped between pressing units, preferably pressing strips or pressing plates, immediately prior to the cutting operation, whereupon they are trimmed to size by means of three cutting operations (top edge, foot edge, front edge). There is in principle no fixed order for these cutting operations; it may also vary depending on the product.

Also known are three-knife trimmers where the book blocks are pressed and retained between pressing pads and cutting cassettes for the cutting operation. When the pressing pad is raised, the cut book block is fed out and a new printed product to be cut is introduced. The printed product is moved into position by a centering device and then clamped by the descending pressing pad. The knifes move against the book in a swinging shear cut, thereby performing the cutting operation. After the cutting operations have been performed on all edges, the pressing pad is raised and the next work cycle may begin. This three-knife trimmer design, however, is not capable of a quick format change. The pressing pad and the cutting cassette are tailored to the format to be processed and can only be replaced or repositioned by stopping the machine.

EP 3 285 978 B1 describes an apparatus for performing printed-product-specific cutting operations. This apparatus generally has a feeding device that conveys the printed product to the first cutting station, as well as an outfeed device which conveys the printed product onward after it has passed through the third cutting station. Interposed therebetween is the second cutting station, which performs the front cutting. Thus, the printed product is subsequently transported from one cutting station to the next, namely from the first cutting location, where the cutting operation for the first format edge of the printed product takes place, be it a head or foot cut, to the second cutting location, where the front cut takes place, whereupon the printed product is transported to the third cutting location, where the cutting operation for the third format edge takes place, be it a foot or head cut. The transport from one cutting location to the next is accomplished by at least one transport unit, the transport unit having at least one gripping means (gripper) that fictionally grips the printed product by the spine and conveys it from one cutting location to the next in a suspended condition, which is an essential feature of this apparatus.

With regard to the prior art, reference is made to EP 3 482 892 A2, which is essentially the basis of the previous EP 3 285 978 B1, which has been further developed in such a way that the edge-specific cutting operation is now carried out at at least one cutting location, if required at all three cutting locations, by a cutting tool, and that, after a first edge-specific cutting operation, at least a second subsequent edge-specific cutting operation can optionally be carried out.

Using the example of the second subsequent partial cut on the front part of the printed product, i.e., at the second cutting location, this additional partial cut is accomplished using the following procedure:

Once the first partial cut has been made, the printed product is frictionally clamped for a short time by a gripper belonging to the transport unit of the transport device, whereupon the clamping device acting against the printed product for carrying out the cutting operation opens slightly so that the printed product is no longer conditioned by this clamping device in terms of movement; i.e., the printed product is now held by the gripper in a suspended condition;

Intermediately, the gripper belonging to the transport unit frictionally lockingly engages the printed product at the location, whereby and the printed product then assumes an intertemporal local position when the clamping device is open.

While the clamping device remains open, the transport unit belonging to the transport device moves the clamped printed product downward by an amount, exactly by the amount that was allotted for the second partial cut, and thus the original plane of the knife remains unchanged also for this subsequent cut.

After the displacement by the amount of the cut, the clamping units of the clamping device once again frictionally lockingly engage the printed product in a manner synchronized with the gripper of the transport unit;

Immediately before the second partial cut is started, the printed product is engaged again and pressed by a cutting-location-specific, preferably bar-shaped pressing unit, which exerts the ultimate pressure on the printed product in the region of the cutting plane;

Once the second partial cut is completed, the pressing unit travels back in a manner synchronized with the cutting tool, the clamping jaws or pressing strips of the clamping device open, and the printed product is then conveyed onward to the third cutting location by the further transport unit of the transport device.

In order to avoid unnecessary repetitions regarding the process, reference is made to FIG. 17 and its description in EP 3 482 892 A2.

### SUMMARY

In an embodiment, the present disclosure provides

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows translational movements of the transport unit and gripper within the X and Y planes in an apparatus;

FIG. 2 shows an overall view of the three-knife trimmer, captured by a snapshot of the transport unit;

FIG. 3 shows a further view of the three-knife trimmer with a further snapshot of the transport unit;

FIG. 4 shows an infeed device for the book blocks into the three-knife trimmer;

FIG. 5 shows an infeed wheel as a feeding device;

FIG. 6 shows a transport clamp;

FIG. 7 shows a modular cutting device including the three cutting stations;

FIG. 8 shows a snapshot of the operation of the pressing strips during front cutting;

FIG. 9 shows another snapshot of the operation of the pressing strips during front cutting;

FIG. 10 shows another snapshot of the operation of the pressing strips during the cutting operation at the front cut location;

FIG. 11 shows different configurations of the jaw fold and cover;

FIG. 12 shows translations of the printed product via the intermediate station at the second cutting station, with the spread-initiating elements;

FIG. 13 shows a configuration of the spread-initiating elements in operative association with each other;

FIG. 14 shows the spreading dynamics, coupled with the pressing of the printed product;

FIG. 15 shows an overall view of the elements of the intermediate station, illustrating how the printed product is introduced to spread the jaw fold or cover;

FIG. 16 shows a block diagram relating to the sequences during subsequent cutting operations at the cutting stations, highlighting the sequences at the second cutting station for the front cut;

FIG. 17 shows a rotatable four-clamp system as a clamping device and outfeed device;

FIG. 18 shows the ultimate pressing of the book block for the cutting operation;

FIG. 19 shows the profile of the forces exerted by various clamping elements during a cutting operation;

FIG. 20 shows a leveler slide for exerting vertical force on the printed product;

FIG. 21 shows a leveler slide for exerting horizontal force on the printed product; and

FIG. 22 shows a further transport configuration of the transport units.

### DETAILED DESCRIPTION

Aspects of the present disclosure provide an apparatus configured as a three-knife trimmer, which is improved such that, in addition to conventional operation, this apparatus is now also able to process printed products which are extended with at least one jaw fold or cover, as required and without cycle interruptions.

According to an aspect of the present disclosure, the cutting operation in the region of the front cut is concerned here, which front cut, as already mentioned, can be carried out according to a known mode of operation, but which, in addition, is also characterized by a cutting operation which is novel in that it concerns the cyclic gripping of printed products extended with a jaw fold or cover, which have to remain intact in their original configuration while the front cut is being made, i.e., must not be trimmed, which would immediately result in the destruction thereof. This is accomplished by taking measures before this front cut, which measures are aimed at preserving the configuration of the basic perimeter of the jaw fold or of the cover. The other cutting operations, i.e., head and foot cuts, remain unaffected by this; they can be carried out as usual.

A “jaw fold” or “cover” refers to a special design of the protective cover of the printed product, with at least one formation implemented inwardly toward or outwardly from the printed product. The term “printed products” as used herein includes also books, booklets, magazines, etc. Applicant has given the commercial name of “InfiniTrim” to a “three-knife trimmer”.

According to an aspect of the present disclosure, the point here is that while, on the one hand, the occurring cutting operations are in principle carried out as heretofore, in particular in the case of this front cut, the present disclosure, on the other hand, provides an apparatus and a method where the jaw folds or covers of the printed product are not affected by the front cut.

This means that the cutting operation(s) for the front cut is/are carried out in such a way that the jaw fold or cover according to the causal configuration are not affected thereby. This is achieved by initiating a predetermined and predominant opening (spreading) of the jaw fold or cover prior to this cutting operation, the magnitude of the predetermined and predominant opening being maintained at least until after the completion of this cutting operation.

The reason for bringing about a spread even in the case of a plain cover, i.e., one without a jaw fold, is that it can be configured with a special dimension relative to the front-trimmed edge, which could be destroyed by a cutting operation, for example always in those cases in which the cover is intentionally provided slightly recessed or slightly protruding from the trimmed edge.

This is based on the assumption that the present disclosure is based on a three-knife trimmer and a method for operating the same, which is able to continuously process printed products of the same or different formats and thicknesses; i.e., by definition, to trim them to format size, at a high cutting rate and with high cutting quality, even if the printed products are configured with at least one jaw fold or cover, which, in addition, may be configured differently, for instance, when they are provided individually or on both sides and these are disposed both inwardly or outwardly. Thus, the present disclosure also includes further embodiments which are directed to the trimming of printed products having a jaw fold or cover.

Taking into account a process according to which the printed product is provided with at least one jaw fold or cover, various translations and measures are implemented for the printed product in the region of the front cut in accordance with the present disclosure. A central measure in this context is that the printed product (also called “book block”) passes through an integrated intermediate station prior to the front cut, which intermediate station is provided with elements that initiate and consolidate the spread of the jaw fold or cover, and, in addition, further measures are then provided which can maintain or increase the spread up to the front cut location.

In this context, aspects of the present disclosure are based on the fact that the front cut can, in principle, be carried out as described previously, even if at least one jaw fold or a cover is present according to the present disclosure. In such a case, the initiated measures are intended to ensure that the cutting operation can take place while maintaining one-hundred percent the given geometric configuration of the jaw fold or of the cover. Accordingly, the aim is to ensure that the jaw fold or the cover remains unaffected during this cutting operation, both in the case of a one-sided and a double-sided design, whether, in the case of a jaw fold, they are disposed inwardly and/or outwardly on the printed product; i.e., inventive elements used ensure that the execution of the front cut remains limited to the printed-product body, which is to be considered separately from a cover of the printed product, but this can only be reliably achieved if the spread of the jaw fold or of the cover assumes and maintains an effective and lasting opening throughout the duration of this cutting operation. For quality reasons, care must be taken when forming this spread to ensure that the jaw fold or cover does not get permanent creases or kinks, i.e., that the body-related spread always behaves reversibly in terms of shape and structure after the front cut has been completed.

During the translation of the book block to be performed after the completion of the first cutting operation (top or foot edge), the printed product intermediately passes through an intermediate station upstream of the cutting operation for the front cut, in which intermediate station the jaw fold or the cover undergoes (undergo) a flexibilized spreading by the elements acting there to thereby create the prerequisites to ensure that it remains impossible for the jaw fold or cover to be trimmed during the front cut, this opening as such consisting in that the end part of the jaw fold or of the cover is flexibly raised prior to the actual front cut; i.e., undergoes a spreading, but to such an extent that no lasting deformation of the structure of the jaw fold or of the cover will occur, the same applying also to the further transport of the jaw fold or of the cover within this cutting station. The aim of this procedure is, therefore, that the original structure (elasticity) and nature of the jaw fold or of the cover remain intact during this spreading, i.e., that there will be absolutely no permanent deformation of the jaw fold or of the cover.

In the case of a three-knife trimmer featuring frictional gripping of the printed product along a transfer path, i.e., from one cutting station to the next, provision is generally made for adapted translations of the printed product, which maximally correspond to respective cutting operations, the focus of the present disclosure here being to highlight those translations of the printed product which are operatively connected to the front cut.

This first translation in focus here concerns the transfer of the printed product from the previous cutting station to the station that performs the front cut. This translation can be accomplished in different ways:

Firstly, this translation can be accomplished by a step-by-step procedure in which the printed product initially moves from the location of the previous cutting operation along a vertical or verticalized path until it reaches the operative height of the intermediate station at the beginning of the cutting station for the front cut, whereupon the printed product then performs into a horizontal translation, initially until it is transferred to the intermediate station, which is equipped with elements capable of initiating, respectively consolidating, respectively increasing a spread of the jaw fold or of the cover. This increase in the spread is intended for those cases in which the resulting opening of the jaw fold or of the cover could be too small to achieve the final purpose.

Secondly, such a translation can also be accomplished by transferring the printed product from the location of the previous cutting operation to the intermediate station by way of a continuous intersectoral path of the type of a transverse hyperbolic curve, whereupon the further procedure is as described under a).

The elements of the intermediate station that are provided for this purpose therefore have the function of initiating measures which serve causally to fully preserve the integrity of the jaw fold or of the cover in the subsequent front cut-specific cutting process, i.e., to protect both the jaw fold and the cover by suitably spreading them to the extent that the subsequent cutting operation can be successfully carried out under optimum conditions, in particular also with the involvement of the technical pressing measures for achieving optimal pressing of the printed product prior to and during the front cut.

In particular, therefore, by initiating this jaw fold-or cover-related spreading (opening in combination with lifting and/or deflecting), those space conditions are to be created that will allow the cutting operation to be carried out under the best possible force-related pressing against the printed product, with a direct effect on the dynamics of the cutting device, which is preferably operated with at least one knife. For this purpose, the intermediate station is made up of a body, preferably in the form of an opening sword, along and beyond the contour of which is transported the printed product (book block) with the jaw fold or cover. This opening sword penetrates into the book block with its tip between the jaw fold or cover and the printed-product body, and thus initiates the dynamics that leads to a spreading opening. This tip first initiates a position-dependent opening, thereby creating the prerequisites that allow the jaw fold or the cover to subsequently slide over the opening edge of the opening sword, thus initiating a specific spreading of the jaw fold or of the cover relative to the book block body, and thereby generally creating the prerequisites that allow the following cutting operation to be reliably carried out independently of the size and configuration of the jaw fold or of the cover.

In the case of the present disclosure, the protective cover of the printed product has different embodiments, which take the form of a jaw fold or cover. The jaw fold itself may be arranged inwardly toward or outwardly from the book block. Such jaw folds, respectively covers, may be present on both sides of the book block. As for the spreading of a cover, reference is made to the explanations given previously. The opening sword itself is composed:

Of an initial opening edge disposed in the flow direction, which extends horizontally, quasi-horizontally, to obliquely; and

Of an opening blade which is disposed downstream of the opening edge and starts with an opening blade in the form of a pointed edge.

The opening point of the printed product is generally defined by the opening edge and opening blade in operative connection with one another. In particular, this opening point is given when the printed product is in contact with the opening sword and the opening of the jaw fold or of the cover begins or is initiated.

The translation for initiating and creating the opening of the jaw fold or the cover can occur continuously, i.e., without stopping before the opening edge of the first element, or may also take place by an intertemporal stopping directly before the mentioned opening edge. This, therefore, creates the prerequisites that allow the initiation of the spreading of the jaw fold or of the cover to be effectively assisted by a statically acting air jet. This air jet may also come to be implemented if the printed product is transported continuously, i.e., without stopping before the opening edge, regardless of whether the cut part or the still uncut part of the printed product approaches the opening edge.

In addition, via its first element, which is in the form of the previously mentioned opening sword that serves to initiate and consolidate the spread of the jaw fold or of the cover, the intermediate station is in operative connection with other elements, which preferably extend over the entire operational path of the cutting station intended for carrying out the front cut, and which, when necessary, are used to maintain and increase the initial spread of the jaw fold or of the cover; i.e., the opening sword first passes the created spread to one or two rails extending parallel in the region of the front cut, which rails, as already described above, extends along the entire operational path of the cutting station, these rails extending parallel on both sides of the passage of the printed product such that printed products with two jaw folds or covers, i.e., jaw folds or covers on both sides or double jaw folds or covers, can also be processed.

The spacing between the two parallel rails is dependent on the thickness of the respective printed product, this distance being adjustable by controlled units, and preferably only one rail producing the required spacing by a mechanical, hydraulic, pneumatic, electric drive. However, it is also possible that both rails may perform the required control to produce a new distance, cither simultaneously or in a phase-shifted manner. In the latter case, it is also to be taken into account that this could result in a lateral displacement of the pressing strips, respectively pressing bars, as compared to the original cutting sequences, which could be coped with by these pressing strips or pressing bars compensating for the displacement of the rails relative to each other in terms of magnitude, thereby defining a new, adapted cutting plane of the printed product, such that suboptimal cutting qualities can be avoided by such corrections.

These rails are generally configured convexly or quasi-convexly in the form of channels and have the function of taking over and continuing the spread indexed by the opening sword and at least maintaining its degree of opening up to the front cut location. The convexity or the inclination profile of the rails may also be designed in such a way that such a spread can increase in magnitude up to the front cut location.

Multiple cutting of a printed product with a jaw fold or cover is also intended to be part of the present subject matter of the present disclosure. In this connection, it must also be taken into account with regard to the two configurations that an initial spreading of the jaw fold or of the cover could possibly be omitted in the case of a first partial cut, and only be made use of in subsequent further cutting. However, for operational reasons, it will be easier to make provision that the jaw fold or the cover is spread to a sufficient extent right from the start. In that case, the infrastructure of the cutting operations would have to be adapted accordingly along the process. Therefore, a variant that can be easily taken into consideration is to return the printed product to a position before the opening sword after the first partial cut, and to there effect the spreading of the jaw fold or of the cover as described in detail above. This procedure ensures that the physical integrity of the jaw fold or of the cover is reliably maintained.

The three-knife trimmer, which forms the basis here and which is to be integrated with a spread of the jaw fold, makes it possible to process new configurations of printed products (jaw fold, cover), it being possible for the operational implementation of the new types of printed products to be realized even with large and smallest print runs, the latter down to 1 piece, so that this operation can be performed continuously in a cyclic mode without downtime required for continuous machine-internal adjustments in the case of different sizes and thicknesses of the printed products, regardless of whether the cutting procedure is carried out mono or by partial cuts.

Aspects of the present disclosure can be characterized as follows: an object of the present disclosure is achieved by an apparatus and method where cutting operations are carried out on at least one open format edge of at least one printed product. As far as the apparatus is concerned, the apparatus has at least one feeding device in operative connection with a first cutting station, where at least one cutting operation is performed on a first format edge present there. Furthermore, the apparatus has at least one outfeed device in operative connection with a last cutting station, in which a cutting operation aimed at a second format edge of the printed product is carried out, at least one further intermediate cutting station being disposed between the first and the last cutting operation, in which intermediate cutting station a cutting operation aimed at the front cut of the printed product takes place.

During the cutting operations, the printed product itself is gripped by at least one clamping device, sometimes also called “pressing device,” which exerts for the exertion of a pressing force in operative connection with a cutting device, the printed product being conveyed in a suspended condition from one cutting station to the next by at least one transport unit with a force-exerting gripping means, the cutting station operable for carrying out the front cut being equipped on the input side with at least one first element whose contour is configured to initiate a spread on a jaw fold or a cover of the printed product in the transport direction and to also implement it, as required, in such a manner that such a spread is produced at this location, the opening of which spread being such that the downstream front cut can generally be carried out without restrictions, whether directly at the location of the spreading or downstream at the location of the originally planned cutting operation. From this point of view, when the front cut is carried out directly at the cutting location where the spread is created, the cutting operation is advanced to an earlier point compared the original disposition. This would have the advantage that the spread of the jaw fold or of the over would no longer have to be passed over additional devices.

However, in the case of printed products with an implemented jaw fold or cover, starting from the three-knife trimmer enhanced according to the present disclosure, one relies on the predetermined process in that at least one second element is disposed immediately downstream of the first element, which second element at least takes over the spread defined by the first element, maintains it in terms of magnitude up to the front cut location, or increases this spread in a regular or irregular manner, with the ultimate purpose of ensuring that the front cut operation is carried out with a sufficient safety distance from the jaw fold or the cover.

Normally, the printed product has at least one jaw fold or cover. The jaw fold may be configured inwardly or outwardly. If the printed product has two jaw folds or covers disposed on the book side (see above under para. 0015), reliable spreading can only be accomplished if the elements provided for this purpose are in use on both sides of the printed product being transported. In such a case, which usually represents the inventive, basic design of the apparatus, there are disposed two first and two second elements, which are spaced apart and extend in parallel to one another, the degree of this spacing being controlled by mechanical, pneumatic, hydraulic or electrical means so as to create a spacing according to the respective thickness of the printed product; i.e., such mechanism allows printed products of different thickness to be continuously fed to the front cut location. Such an adjustment of the distance is preferably to be implemented also in the case of a single-side jaw fold or cover, whereby the printed product is laterally adequately supported during transport toward the front cut location along the second element not in use.

In order to avoid unnecessary repetitions regarding the shape and operation of the opening body (configured as an opening sword), reference is made here to paragraphs [0023]-[0029]. Specifically, this basic description of the present disclosure is therefore concerned with demonstrating that the opening sword has a course-setting opening blade which, at the start of the translation taking place there, penetrates into the printed product in the region of the jaw fold or of the cover and thus initiates the causal spreading between the jaw fold or cover and the printed-product body. The further shape of the opening sword has a contour which is in conformity with the flow and gradually increases in the transport direction, which ensures that the spread of the jaw fold or of the cover is gently widened to a certain extent until an opening is reached at which the front cut can be carried out in an unloaded manner with respect to the jaw fold or the cover. If this initial spread is to be maintained up to the further downstream front cut location within this cutting station, the already mentioned second element, which extends along the transport path and preferably has the shape of a convex or quasi-convex channel, comes into action. This channel may have a regular shape in the transport direction, whereby the spread created by the opening sword can be maintained until the front cut is effected. However, this channel may also have a shape designed to increase the spread in such a way that the initial spread undergoes an increase in its opening in the transport direction in order to then be able to have more free space with respect to the jaw fold or the cover during front cutting. Furthermore, there may be provided guide plates to support the channel.

The clamping device disposed in the second cutting station for providing the pressing force acts stationarily on one side of the printed product, while on the other side, the clamping device takes place in advance mode. However, it is also possible that the pressing force may be produced by an advance movement on both sides of the printed product. This clamping device is composed, at least on the advancing side of the printed product, of individual vertically or quasi-vertically cascaded pressing strips, which come into action only individually during spreading. During the pressing of the printed product directly in the region of the cutting operation, the fixed and/or movable pressing strips disposed below the spread jaw fold or cover act as part of the assembly, these finally providing the ultimate pressing force for the cutting operation.

The apparatus is further equipped with a feeding device, which, as the name suggests, implement feeding operations for receiving and aligning the introduced printed product, which, after the alignment is completed, is fed immediately to the first cutting operation disposed there. The feeding device is preferably composed of a rotatable wheel designed in a rake-like manner, which takes a printed product initially resting on the spine, clamps it by the action of a force, and transfers it by a corresponding partial rotation to a spine-related suspended position, in which position the cutting operation is then carried out, whereupon the printed product is then taken by the transport unit and transferred to the next cutting operation.

The apparatus is further composed of an outfeed device, which operates in the region of the third cutting operation and is operated according to the following criteria:

The outfeed device is operated by a wheel operating in a multi-part manner;

The outfeed device has a pressing device composed of at least one first and at least one second pressing bar and at least one second pressing bar, which exert the pressing force for the cutting operation;

After the cutting operation at this third cutting location, the multi-part wheel performs a partial rotation, by which the printed product is transferred into a removal position; and

At least one pressing bar is operated by a mechanical, pneumatic, hydraulic or electric drive.

The pressing force that can be generated for the pressing of the printed product in conformity with the cut and the generation of the cutting force for the operation of the cutting device at the respective cutting location may be provided by one and the same drive, regardless of whether the pressing bars operate directly or indirectly. However, it is also possible for the two forces to be generated by individual drives, which then results in operational advantages, namely that each force can be provided individually.

An object of the present disclosure is further achieved by a method for operating the apparatus for carrying out cutting operations on at least one open format edge of at least one printed product, the method also having at least one feeding device in operative connection with a first cutting station, where at least one cutting operation is performed on a first format edge ready for cutting there. Furthermore, the apparatus also has at least one outfeed device in operative connection with a last cutting station, in which a cutting operation aimed at a second format edge of the printed product is carried out, at least one intermediate cutting station being disposed between the first and the last cutting operation, in which intermediate cutting station a cutting operation aimed at the front cut of the printed product is carried out. During the cutting operations, the printed product is generally gripped by at least one pressing device, which implements the exertion of the required pressing force for the operation of the cutting device, the printed product being conveyed from one cutting station to the next by at least one transport unit having integrated force-exerting gripping means. The method further has the following process steps and embodiments:

The cutting station operable for carrying out the front cut is supplemented on the input side with an intermediate station, which is composed of at least one first element whose contour is configured in such a way that the protective cover of the printed product to be processed there, which protective cover is formed with a jaw fold or a cover, is spread in the transport direction, at least one second element being disposed immediately downstream of the first element, which second element at least takes over the spread created by the first element and passes it on to the front cut location, the degree of opening of this spread being increased as required by the second element, whether in a regular or irregular manner.

With regard to the change in the spread of the jaw fold or of the cover, which is initiated by the first element, the second element, which is preferably in the form of a convex or quasi-convex channel, takes over this given spread, maintains it unchanged up to the front cut location, or preferably successively increases the spread along the further transport path to the front cut location, this being achieved by suitably selecting the convexity of the channel, so that the printed-product body is characterized by a larger free zone with respect to the spread of the jaw fold or of the cover in the region of the front cut.

With regard to the shape of the first element, the first element has the configuration of an opening sword, which is formed on the input side by an opening blade which, at the beginning of the translation related to the printed product there, a penetration between of the jaw fold or of the cover with respect to the printed-product body takes place, such that a spread is thereby initiated. The further shape of the opening sword has a contour which gradually increases in the transport direction and which is configured in terms of flow in manner that ensures that the spread of the jaw fold increases continuously and gently until a certain degree of opening is reached so as to thereby achieve at least the spread at which the front cut can be carried out in an unloaded manner. If this initial spread is to have a sufficient opening for carrying out an unloaded front cut, it is not further increased along the second element. In contrast, however, if this spread from the first element has an insufficient opening, then, in such cases, the second element comes into action, which is no longer designed only to maintain the degree of opening, but is capable of increasing it. This can be accomplished, for example, by flexible changes in the convex or quasi-convex channels and/or guide plates.

As already explained above, the first element has the shape of an opening sword, which is substantially composed of an opening blade formed on the input side. Penetration of the opening blade into the printed product in the region of the jaw fold or of the cover during a first translation initiates the spreading of the protective cover of the printed product, which protective cover is extended with a jaw fold or cover. This spread may then be further increased by the further translation along the contour of this opening sword, which is accomplished by designing the contour to increase in volume at the flanks.

If the jaw folds or covers as well as the various dimensions of the printed products are to be gripped, and the cycle-compliant processing thereof is to be ensured, the inventive method also has two first and two second elements on both sides of the printed product, as already explained above for the inventive apparatus, which first and second elements are coupled to at least one drive for spacing them apart exactly according to the thickness of the printed product to be processed. The intermediate space so created, including a narrowly limited allowance, should correspond 100 percent to the thickness of the printed product, in order that the first and second elements in operative connection with one another can ensure reliable spreading of the jaw folds or of the covers.

Generally, but especially in the second cutting station for carrying out the front cut, the pressing devices disposed there for providing the pressing force against the printed product should be stationary on one side, while on the other side, the pressing may be accomplished by an advance movement. However, it is also possible that the pressing force is produced by an advance movement on both sides of the printed product. This pressing device is composed, at least on the advancing side of the printed product, of individual vertically or quasi-vertically cascaded pressing strips. It is important that prior to the cutting operation, only those pressing strips come into action which ensure that no damage occurs to the jaw fold or to the cover. Below the spread, sufficient space has now been provided so that the printed-product body is there gripped directly in the region of the front cut on both sides by at least one fixed and/or movable pressing bar to apply the final pressing force, whereby reliable operation is then ensured for the front cut to be made.

According to an embodiment, the present disclosure is further implemented by a method for operating the apparatus for carrying out cutting operations on at least one open format edge of at least one printed product, which method focuses on designing the transport with a further implementation according to the present disclosure, bearing in mind the fact that some aspects thereof can be adopted unchanged. The apparatus underlying here has at least one feeding device in operative connection with a first cutting station, where at least one cutting operation is performed on a first format edge present there, and at least one outfeed device in operative connection with a last cutting station, in which a cutting operation aimed at a second format edge of the printed product is carried out, at least one further, intermediate cutting station being disposed between the first and the last cutting operation, in which intermediate cutting station a cutting operation aimed at the front cut of the printed product is carried out, the printed product being gripped during the cutting operations by at least one pressing device which, in operative connection with a cutting device, exerts the pressing force on the printed product, the printed product being conveyed from one cutting station to the next by at least one transport unit with a force-exerting gripping means.

The cutting station operable for carrying out the front cut is equipped on the input side with at least one first element whose contour is configured to initiate a spread of the protective cover of the there introduced printed product in the transport direction, which protective cover is formed with a jaw fold or a cover, at least one second element being disposed immediately downstream of the first element, which second element at least takes over the spread created by the first element and passes it on to the front cut location, while either maintaining or increasing the opening, as already explained above. If the front cut is to be subjected to a multiple cut, then, as a variant embodiment, provision can be made that the spread is increased by the first and or the second element to such an extent that the front cut operation can be carried out immediately subsequently at the cutting location by advancing the portion to be trimmed.

In order to perform multiple cuts at the front cut location, based on an apparatus already described, provision can be made, as a variant embodiment, that the first cutting operation is carried out without spreading the jaw fold or the cover, i.e., as is usually the case. After this first cut, which may readily be complemented by a subsequent one, the printed product is then returned to the intermediate station with the first and second element for performing the spreading, whereupon the final cutting operation of the front cut can then be carried out.

The apparatus has a plurality of transport units, which are guided along an endless guide path, cach transport unit being individually loaded with at least one printed product in the region of the different cutting stations for the respective cutting operation. After exiting the last cutting station, each transport unit is returned unloaded via an endless path to the first cutting station so as to there receive a newly delivered printed product prior or subsequent to the first cutting operation and convey it to the other cutting stations according to a defined cycle to carry out the pending cutting operations. With such a transport configuration, provision can easily be made that all cutting operations can be performed on the printed product at a central cutting station, such that the respective printed product gripped is conveyed directly to a central cutting station by the transport unit, even if such transport unit is configured to circulate, and that at the central cutting station, all cutting operations are performed in such a way that the motion dynamics of the force-applying pressing elements and of the cutting devices are coordinated with one another by non-colliding cutting sequences.

Furthermore, in this central cutting station, measures are implemented which are aimed at spreading a jaw fold or cover belonging to the printed product. Due to the centrally performed cutting operations, the means for creating this spread during front cutting do not act in a manner that would hinder the entire cutting process, such that these means either assume an assigned local position or can be intertemporarily activated and deactivated. It is obvious that in such a configuration, the spreading should immediately create the opening at which the jaw fold or cover remains completely unaffected by the front cut in its structure.

The present disclosure is described in more detail below with reference to the figures illustrating exemplary embodiments. In the following, the printed product is also referred to as a book block, other variants of printed products, such as brochures, also being included.

### Exemplary Embodiments

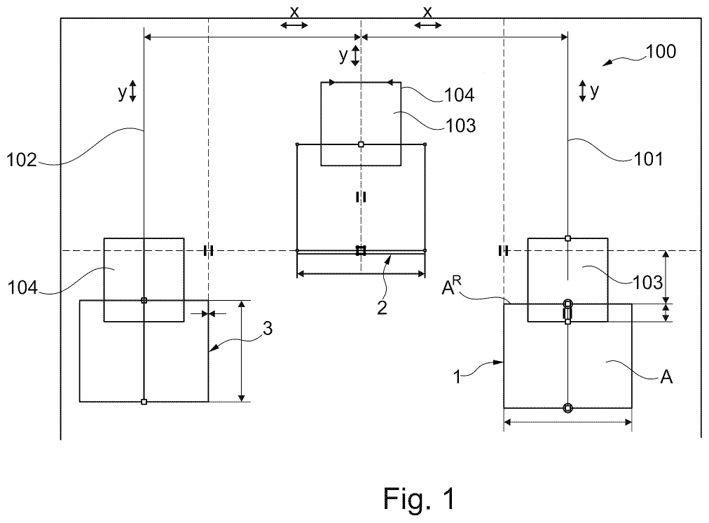

FIG. 1 shows in schematic form the translational movements of a transport unit belonging to a three-knife trimmer 100, the movements of which unit are performed from two movable, printed product-related transport units 101, 102, these transport units being in operative connection with one another, as will be described in more detail in the description of the other figures. At their ends, the transport units have printed product-related grippers 103, 104 with clamping jaws, which cyclically and frictionally grip one after the other the spine A^{R} of the printed product A to be trimmed. Often, the term “book block” is used, which is understood to also include other printed products, such as booklets. The transport units themselves perform the following coordinated, controller-assisted translational movements in relation to the cutting locations 1, 2, 3, which are also referred to as cutting stations:

First transport unit 101 actively takes printed product A at the first cutting location 1 once the first cutting operation is completed there. Then, the first transport unit transfers printed product A to second cutting location 2, and, once the printed product has been delivered, returns to the starting position at the first cutting location 1 to be available there for receiving another, subsequently delivered printed product, so as to this after the first cutting operation at the first cutting location 1 has been carried out. In the meantime, second transport unit 102 takes printed product A immediately after the cutting operation at the second cutting location 2 is completed, and transfers it to third cutting location 3, where the third cutting operation takes place. Then, second transport unit 102 returns to second cutting location 2, where another, already trimmed printed product A delivered by the first transport unit is already standing by to be picked up and transferred to third cutting location 3.

The translational movements of the transport units 101, 102 with the integrated grippers 103, 104 cover two or three planes, respectively. Specifically, in the first plane X, the printed product is transferred from one cutting location to the next; in the second plane Y, the printed product is loaded and unloaded at the respective cutting location. Optionally, a third plane Z is also used, in which a lateral adjustment (offset movement) with respect to the stationary, printed product-related clamping elements is carried out as required at the respective cutting location of three-knife trimmer 100.

In the following, the action of the translational movements of the transport units will be described on the basis of the grippers since it is these that best depict the operations of the three-knife trimmer.

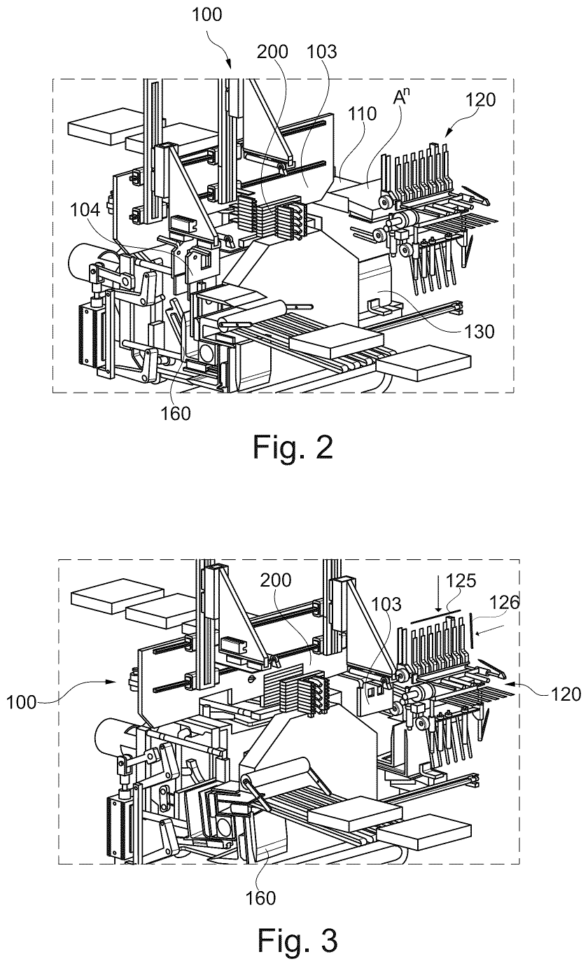

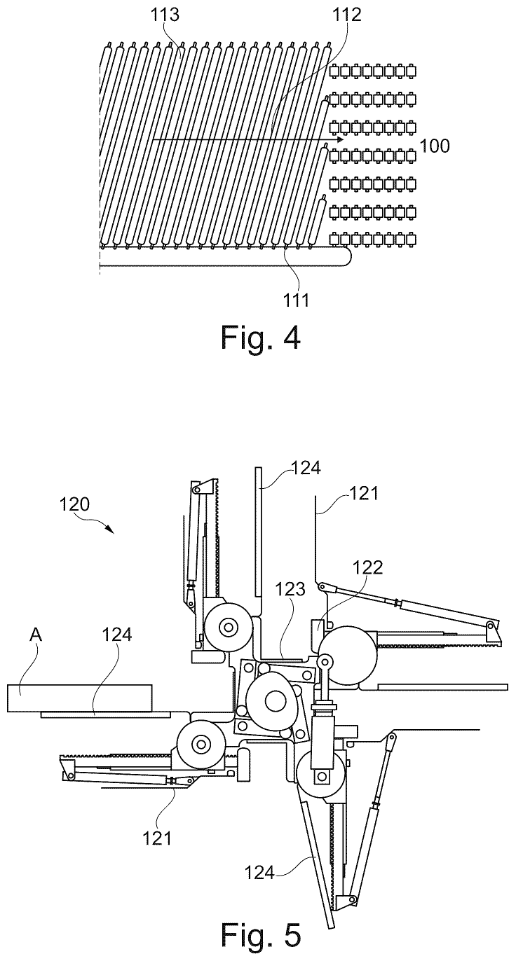

FIGS. 2 and 3 are 3-D views of three-knife trimmer 100. The book blocks Aⁿ are fed to three-knife trimmer 100 in a horizontal position via a conveyor belt 110, spine first and at an approximately equal distance from one another. The approximately uniform feeding of the book blocks is either accomplished by cyclic delivery of the book blocks to the conveyor belt of the three-knife trimmer, or it is initiated upstream of the conveyor belt by devices known from the prior art.

In another embodiment, the book blocks are delivered to conveyor belt 110 of three-knife trimmer 100 at an irregular pitch. A cycle timing device ensures that the pitches (distance from a leading book spine edge to the book spine edge of the next book block) do not fall below minimum values.

The moment at which a book block arrives at the conveyor belt of the three-knife trimmer is detected by a sensor. If the distance between the book blocks is now greater than the minimum pitch, the controller reduces the speed of the translational movements of the three-knife trimmer, whereupon the three-knife trimmer is synchronized with the cycle of the delivered book block. If the pitch exceeds a maximum value, the controller is programmed to be able to generate empty cycles on the three-knife trimmer.

The book blocks A″ are aligned on conveyor belt 110 at the head or foot end by a fixed stop. This may be accomplished by a transport section having slightly skew transport rollers, or by other measures known from the prior art. The other modules of the three-knife trimmer illustrated in FIGS. 2 and 3 are described in detail in the following figures.

A leveler slide 125 (see FIGS. 3 and 14) is in operative connection with infeed wheel 120 (feeding device) and is intended to be used in addition to the measures described above to ensure secure positioning of the book block with respect to the stop surfaces thereof.

In the case of individual book blocks, in the case of stacked book blocks, as well as in the case of stacked booklets, a stop surface is taken as the basis for the alignment by the spine side of the printed products with respect to a fixed bearing surface inside infeed wheel 120. In addition, it has to be ensured that at the head end and/or foot end of the printed products have a corresponding downward position in the transport direction prior to the first cutting operation.

In the case of book blocks, this is accomplished in that one or more printed products is/are taken, according to the format, from infeed wheel 120 by transport clamping device 130 under the control of a sensor that is responsive to the outer edge of the overhanging jaw fold or of the cover (protective cover) or of the book block itself in the region of the head part or foot part, respectively. This ensures that the edge zone cut at that point on the book block has a matched size.

In the case of a stacked bundle of individual booklets, lateral means that ensure

uniform alignment of the cutting-location-side edges of said bundle should preferably be provided before the first cutting operation.

Accordingly, the function of infeed wheel 120 is to swing a hinged, rake-like guide against the book block so that, following a 90° rotation, the block, now resting on the spine, cannot fan out or fall or tip over. The rake-like guide is coupled to the clamping unit, which briefly clamps the book block in a position resting on the spine and is kinematically designed such that the rake-like guide may be transferred into a position dependent on the book thickness. Thereafter, the clamping unit opens again slightly so that the book block, as a result of gravity, aligns the position of its book block spine side in a corrective manner against the stop surface of the infeed wheel. The clamping unit then closes again, whereupon the book block is held in a defined position. This procedure, which per se is optimized, thus ensures that the spine side of the book block assumes a defined position that is crucial for the subsequent cutting operations.

Nevertheless, from a qualitative point of view, it is right to provide additional measures that can intervene in cases where, in various book block designs, the effect of gravity alone is no longer sufficient to ensure the desired defined position of the spine side of the book block relative to the associated stop surface.

In this context, it is assumed that the book blocks are in most cases configured to have a cover that has a relatively large overhang on all sides (head, foot, front part) with respect to the original book block body. In particular, cutting-related measures are also taken if the book blocks are fed in with finished jaw folds or covers pointing to the front face, i.e., if what matters is that these must not be trimmed when the front cut is made. This overhang in principle does not restrict the cutting process in any way, but could provide logistical advantages due to a standardization of formats insofar as a wide spectrum of different book block formats can be gripped with the same cover size. Accordingly, it can be assumed that a relatively larger overhang will be used in the majority of cases.

To achieve the secure defined position between the book block spine side and stop surface within infeed wheel 120 even in the case of covers having a large overhang in the region of the head, foot and front parts, in order for the present disclosure to make a contribution over the prior art, it is proposed that, during the brief time the clamping unit is open to allow gravity to act on the book block, at least one suitably formed leveler slide 125, 126 (see FIGS. 14 and 15) is operated to directly or indirectly exert the necessary contact pressure on the book block via the cover overhangs so that the book block spine side rests securely on the associated stop surface or is laterally aligned.

For this purpose, the two front-side cover overhangs of the book block are gripped in the pressing plane by brush combs (see FIGS. 14 and 15) oriented at an optimum angle or by other flexible mechanically or pneumatically actuated means, so the resultant contact pressure is transmitted to the body of book block A via cover overhangs in such a manner that it then rests securely on the stop surface disposed within infeed wheel 120, or is otherwise positioned horizontally

Using the example of a brush comb (see FIGS. 14 and 15), the material flexibility thereof is achieved in such a way that the resulting free portion of the brush comb between the two cover overhangs may additionally advance as far as to the front part of the book block as a result of the vertical or quasi-vertical pressing movement, in order to be able to exert an additional or predominant contact pressure there.

In principle, this contact pressure can also be provided when it comes to being able to exert a laterally oriented contact pressure on the head part or foot part of the printed product by suitable means in the form of an additional leveler slide 126 (see FIGS. 3 and 15), with the aim of bringing about the creation of a uniform plane over all the printed products of the bundle so that the edge thereof can then be reliably detected by a sensor so as to be able to produce said optimum position within transport clamping apparatus 130 to allow the subsequent cutting operations (top and foot cuts) to be carried out to the correct size.

As can be seen from FIG. 4 in this respect, the book blocks are pressed against a fixed stop 111 by transport rollers 113 that are slightly skew in transport direction 112, and then conveyed to three-knife trimmer 100. Fixed stop 111 may be configured with a following belt or simply as a fixed plate. Book blocks A″ then reach a transfer position, from which they are raised, for example, by a rotating infeed wheel 120, and rotated into the operative position.

As can be seen from FIG. 5 in this respect, during a first 90° rotation of infeed wheel 120 that performs the function of a feeding device with respect to a subsequent operation. A hinged rake-like guide 121 swings against book block A so that, following the 90° rotation, the book block rests on the spine, so that it cannot fan out or tip over. Rake-like guide 121 is coupled to a clamping unit 122, which briefly clamps the book block resting on the spine, the clamping unit being kinematically designed such that book block can be transferred into a position dependent on the book thickness by means of the rake-like guide 121 belonging to the clamping unit. After that, clamping unit 122 opens again slightly so that book block A, or the spine thereof, as a result of gravity, strikes against stop surface 123 of infeed wheel 120 and aligns itself thereagainst.

Clamping unit 122 then closes again, so that the book block is held in a defined position. The four-part infeed wheel 120 now rotates further over two cycles, in each case by 90°, and transfers the printed product into a suspended position for further transport and further processing. During this rotational movement, the first rake-like guide 121 and a second, also rake-like guide 124 in operative connection therewith are swung slightly away from the book block so that the components of the book block hang vertically downward as a result of gravity alone, while the book block is frictionally held at the book block spine by clamping unit 122. In this position, an open transport clamp (easily visible in FIG. 2, item 130) travels horizontally over the book block toward the book block spine and takes the book block over a large surface arca thereof.

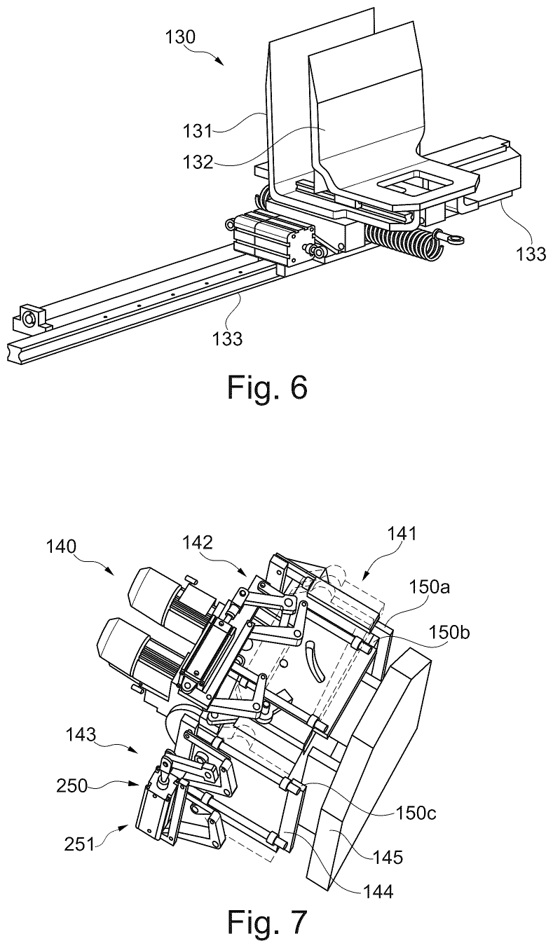

As can be seen in detail from FIG. 6, this transport clamp 130 is composed of two clamping jaws 131, 132, which operates such that one clamping jaw 131 does not perform any stroke while the other clamping jaw 132 performs the entire stroke. Together, the two clamping jaws 131, 132 perform two different offset movements, which are associated with each other in terms of transport with respect to whether the printed product (book, booklet) is then generally transported or performs an empty trip. Optionally, in the case of particular variable and/or inconsistent book block thicknesses, the stroke of the two clamping jaws 131, 132 may be designed individually, so the same or different distances are traveled until the final pressing position is reached.

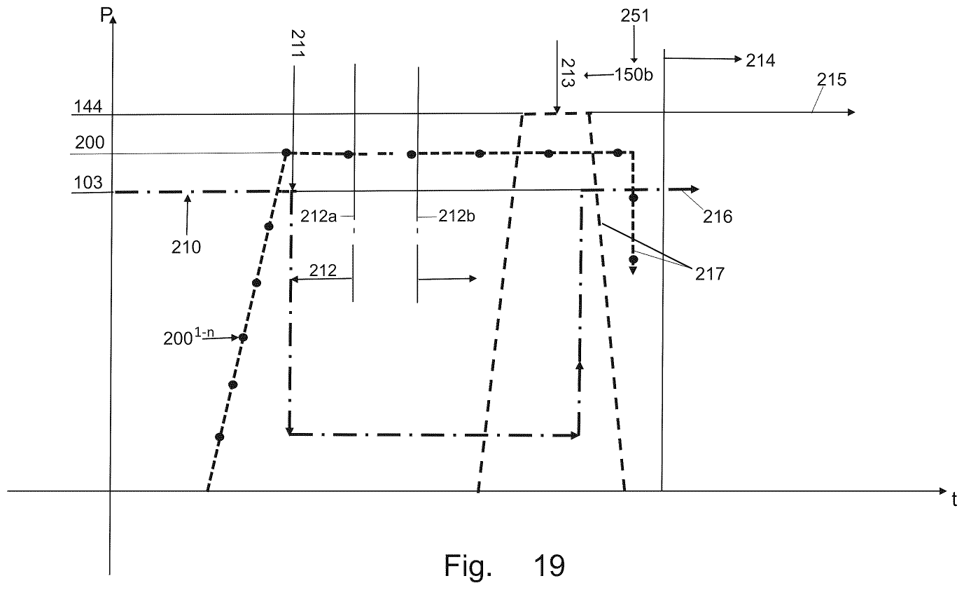

Transport clamp 130 can be moved horizontally by a linear movement device 133. A controlled drive moves transport clamp 130 precisely with respect to a take-over position in conformity with the book block. This take-over position is always dependent on the size of the portion to be trimmed off at the head edge or foot edge of the book block. Once in the take-over position, transport clamp 130 closes and thereby clamps the book block over a large surface area between the front and rear faces thereof. Only the spine region and the region of the respective portion of the book block to be trimmed off are left free. In this regard, reference is made to the description of FIG. 18. Clamping unit 122 (see FIG. 5) now opens and releases the book block spine. After that, transport clamp 130 moves horizontally and transports the book block into the first cutting position (see also FIG. 1, item 1), which is composed of a modular multi-cutting device.

The two clamping jaws 131, 132 may also be operated according to the following criteria: Each clamping jaw is directly or indirectly operatively connected to a drive that operates to bring about the frictional clamping effect. The clamping jaws guided by the drives have adjustable and/or predictively controlled stroke and frictional engagement force profiles for any format shape of the delivered printed product, so the frictional gripping of the printed product carried out by the clamping jaws is designed to be symmetrical or quasi-symmetrical with respect to the center line of the printed product. At least during the operative phase for exerting the clamping effect on the printed product, the clamping jaws perform a mutually coordinated uniform, non-uniform, or adaptive speed profile. This operation may be provided for all the operatively interconnected clamping jaws that form part of the apparatus underlying here.

In this respect, as can be seen from FIG. 7, modular cutting device 140 includes three cutting stations, composed of a first station 141 at cutting location 1 (see FIG. 1), a second station 142 at cutting location 2 (see FIG. 1), and a third station 143 at cutting location 3 (see FIG. 1). For the particular cutting operation, the book block is pressed by a pressing plate 145 and additionally by a pressing bar 144 in such a manner that, during the cutting operation, it is maximally clamped and pressed in the region between the transport clamp and the cutting edge by means of the aforementioned pressing elements. A knife 150b preferably moves along an oblique cut toward a fixed, diametrically opposite cutting bar.

The respective pressing bar 144 is thus ins direct operative connection with the respective cutting device 140 formed by cutting knifes 150a, 150b, 150c, the pressing bar 144 ensuring that the pressing force imperative for a clean cut is exerted on the printed product.

In principle, two main variants are at the forefront for applying the pressing force and for operating the cutting device:

Firstly, as symbolized by item 250 in FIG. 7, there is a coupling between the pressing bar and the cutting device in terms of forces; i.e., the pressing bar force consequently has a fixed value, and the speed profile (pressing speed/acceleration) then generally also has a monotonic shape.

Another variant, as symbolized at item 251 in FIG. 7, lies in decoupling the forces exerted by the cutting knife and the pressing bar from one another, such that pressing bar 144 is then operated autonomously in accordance with the following criteria:

A certain force is built up at the pressing bar as a result of a corresponding torque being built up at the servomotor by a servo drive. The optimal required pressing force on the printed product is determined based on a thickness measurement, which can be casily accomplished by means of stored control profiles. A single calibration is generally sufficient for the detection of a specific thickness variability of the printed products, provided the underlying pressing force characteristic curve can be considered to be constant, which is because the differences between the book block thicknesses within the same job are relatively small.

By contrast, however, it should be taken into consideration that a significant reduction of the pressing speed and particularly of the acceleration can be achieved through the optimization of the pressing stroke, particularly in the case of rigid and/or thin printed products. However, this concept has the advantage that the respective cutting device(s) always operate at the maximum speed, regardless of the production rate, the maximum speed not being limited here by the cutting speed, but instead by the limits determined by the mechanical design. In addition, it is essential that, at a low machine speed, an extended cycle time is available, in particular with regard to operational transport, alignment, and pressing, since the amount of time required for the cutting operation is always the same.

The other two cutting locations are operated by the knifes 150a and 150c, which follow substantially the same pressing and cutting philosophy, as explained above. In the first cutting station, the head region of the book block is cut (see also FIG. 1). However, the possibility of starting the first cutting operation with the foot region of the book block is not excluded, although with some configurations this would require an adjustment of the location of action of the clamp and, if need be, of the cutting device 140, as a result of which it would also be required to address the thickness of the respective cuts, all this taking into account the type of clamping on the book spine side AR (see FIG. 1).

Referring back to FIGS. 1, 2, and 3, during the cutting operation in both the vertical direction (Y-plane, see FIG. 1) and the horizontal direction (X-plane, see FIG. 1), a movable, open first gripper 103 intervenes, this gripper being directed toward the book block spine in the vertical direction. Following the first cut, first gripper 103 takes the book block by the spine, whereupon transport clamp 130 opens. Then, this transport clamp travels to the take-over position for the next book block. First gripper 103 transports the book block vertically upward (Y-planc) from this first cutting operation (FIG. 1, item 1) and then travels to the second cutting position (FIG. 1, item 2) by way of a superimposed, horizontal movement.

The movement path of first gripper 103 in the vertical direction is controlled by the machine controller according to the width of the book block cut, it also being possible for the movement path of the gripper to be independently controlled in general in the horizontal direction with respect to the book block, for instance when a specific gripping position is desired. This is the case, for example, when the format and the portions to be trimmed off in each book block necessitate an asymmetrical or quasi-asymmetrical clamping action or a unilateral clamping action dependent on the center of gravity.

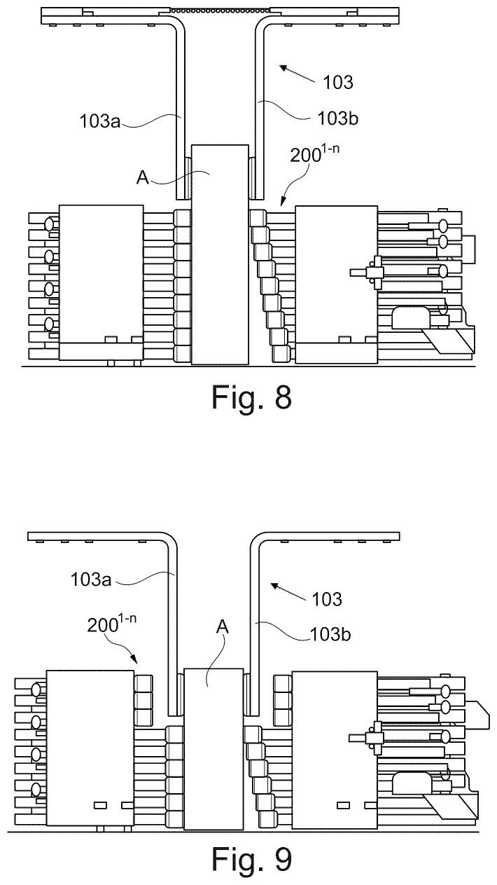

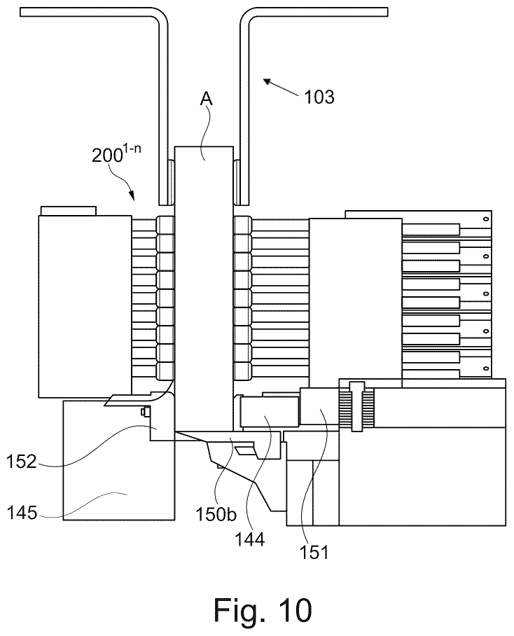

In the second cutting position (FIG. 1, item 2), the book block is by a plurality of pressing strips which belong to a pressing strip group (FIGS. 8-10, item 200), by means of which pressing strips the book blocks are clamped between the front side and the back side. FIG. 10 depicts the pressing strip group in the closed state, while in FIGS. 8,9, the pressing strip group is shown in a partially open state.

As can be seen in FIGS. 8 and 9, the individual pressing strips 200¹⁻ⁿ, close one after the other, starting at the top from the book block spine, so that the air between the individual sheets can be pressed out in a targeted manner toward the cut edge by this pressing procedure, while at the same time smoothing the printed product as a whole. As can also be seen from FIG. 9, the number of pressing strips used is just equal to the number for which there is space between the position of the gripper 103 having the respective clamping jaws 103a, 103b and second cutting station 142 at second cutting location 2 (see FIG. 1). The same clamping jaws 104a and 104b belong to the other gripper 104 (see FIG. 1), which in turns allows the book block to be pressed over a large surface area. In second cutting station 142, the front side of the book block is now cut, this being done in a manner analogous to the manner in which the head edge and the foot edge are cut in the first and third cutting stations 141, 143, respectively.

Once the pressing strips 200¹⁻ⁿ that are being used from the pressing strip group 200 have clamped the particular book block at second cutting location 2 with suitable force (see FIG. 1, item 2), as can be seen from FIG. 10, first gripper 103 can release the book block and be moved back into its take-over position (cutting location 1, FIG. 1) for taking the next book block.

Furthermore, FIG. 10 shows the ultimate force-related retention of book block A during the cutting operation, which is intended to ensure that the cut can be performed to a high quality with the aid of the knife 150b shown. Thus, when the pressing strips 200¹⁻ⁿ being used (see FIGS. 8 and 9) have taken book block A from gripper 103, the pressing bars (item 144) that exert the definitive pressing force on the book block in the direct cutting region come into action. In the process, this force has to be predominant over other pressing forces so that the cut carried out by knife 150b ensures a rectangular, sharp cut edge. The device exerting for pressing force is composed, on the other side of the book block, of a fixedly positioned stop 152 as part of a pressing plate 145 (see also FIG. 7), which pressing plate is sometimes designed such that it can also perform an advance movement along the lines of the opposite, movable pressing bar 144, which is operable by a pressing stem 151 to press against the book block. This pressing stem 151 may, for example, be driven by a motor, hydraulically, or pneumatically, and thus exert the predetermined pressing force on the book block.

In a further embodiment, stop 152 may also be designed to be movable in order to sense the thickness and/or body consistency of the respective book block delivered; in other words, in order that the leading edges of the delivered book block do not encounter any obstructions. This dynamic adjustment of stop 152 may be accomplished by the previously mentioned machine controller.

The other pressing bars (see FIG. 7, item 144) at the other cutting locations 1, 3, which now exert the pressing force in the vertical plane, also function according to the same principle. Here, too, the aim is to ensure a rectangular, sharp cut edge.

As soon as the book block is pressed by the pressing strips 200¹⁻ⁿ, the second cutting operation (front cut) can be carried out. Upon completion of the cutting operation, a second gripper 104 (see FIG. 1) is moved into position and grips the book block in a similar manner to first gripper 103. The force application position of second gripper 104 depends on the dimensions of the book block to be processed, i.e., essentially also on the quality assurance of the cut to be made. Second gripper 104 is moved into a defined gripping position, so that the defined height of the book block is defined for the subsequent third cutting operation (see FIG. 1, item 3).

The here described process execution at second cutting location 2 is extended when it comes to carrying out the front cut taking into account a spread jaw fold or a spread cover at the book block. In this regard, reference is made to FIGS. 12 through 16.

Once the second cutting operation (front cut) is completed, the pressing strips of pressing strip group 200 open, whereupon second gripper 104 grips the printed produced (book block, booklet, etc.), initially lifts it vertically from the cutting position so as to then transfer it into a horizontal translation, and finally vertically lower it in the plane of the next cutting position, in which the third trimming operation (normally foot edge of the printed product) is carried out (see FIGS. 1 and 2). During these vertical translations in the region of at least one cutting position, the gripper loaded with at least one book block also performs a positionally required lateral offset movement, as required, with respect to a pressing surface of the clamping device.

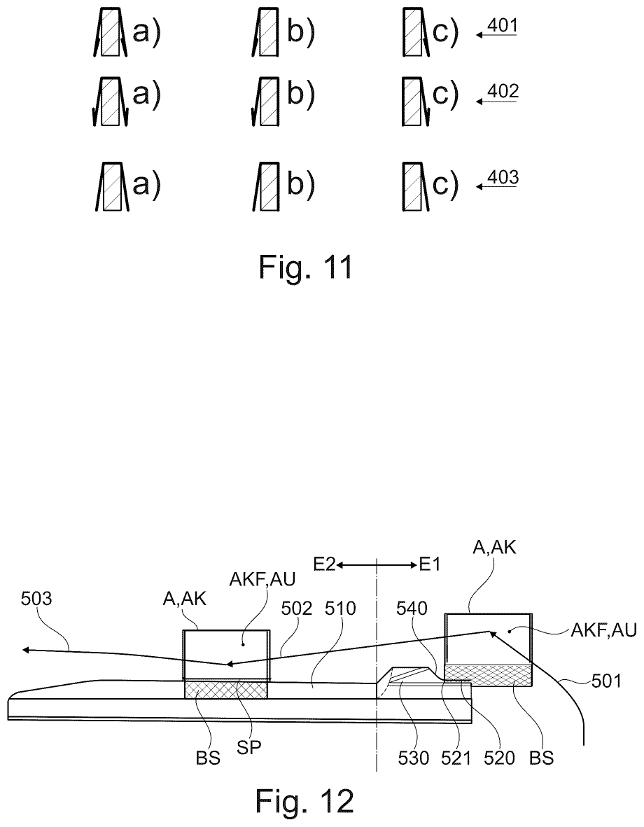

FIG. 11 shows the range of possible variants when there is a jaw fold or a cover that can be gripped by the apparatus and the method in accordance with the present disclosure; for example, the jaw fold variants according to 401 a)-c) and 402 a)-c) and, in addition, also the cover variants according to 403 a)-c) concern the following configurations:

inward flap 401: a) on both sides; b) on one side, left; c) on one side, right

outward flap 402: a) on both sides; b) on one side, left; c) on one side, right

only cover 403, i.e., without jaw fold, but in the same basic configuration: a) on both sides; b) on one side, left or c) right

In all of the variants taken as a basis here, the spreading is carried out according to the same principles, whereby continuous operation is ensured even with constantly changing variants. Any combination of the variants listed here is possible at any time.

FIG. 12 shows the process sequence during the introduction of a book block A formed with a jaw fold AKF or a cover AU into the region of the opening sword 530 for the creation of a spread SP, which is causally implemented to be able to carry out an unloaded front cut. The same procedure can be carried out equally for a jaw fold or a cover. The following steps form the basis for performing the procedure:

By means of a curve-related translation 501, the book block A coming from the edge cut at first cutting location 1 (see FIG. 1), is transported via the underside of opening sword 530 (to both elements, if this is applicable according to 401-403 a)) to opening point 521, which is located at the end of a relatively short section formed as an opening edge 520. Thus, at this position, jaw fold AKF or cover AU of book block A is located above opening edge 520 and immediately before opening blade 540. When the jaw fold or the cover is formed on both sides, the book block body always remains guided between the opposite opening swords.

By means of a further translation 502, book block A is transported to the front cut location at second cutting location 2 (also referred to as cutting station). While book block body AK (see also FIG. 14) of book block A maintains its neutral position along opening edge 520 with respect to the spreading process injected by the opening sword, the jaw fold AKF or the cover is opened by opening sword 540, spreading it away from the book block body, and the further transport of the book block along the contour of opening sword 530 leads to the creation of a real spread.

When this spread is initiated with respect to the jaw fold or cover in relation to book block body AK, the opening process is assisted, as required, by at least one air jet operated from below with the aim of creating a more lasting spread, the degree of this performance being essentially dependent on the nature of the internal configuration of the book block, i.e., on whether the pages are compact or loose.

By means of the further contour of opening sword 530 in the transport direction, the jaw fold or the cover is the spread is initially maximized in such a way that the resulting opening the prerequisites are created that the subsequent cutting operation only affect the book block body due to this spread; i.e., the original configuration of the jaw fold or cover is thus 100 percent maintained.

In order to ensure the dynamics of the spread with respect to the jaw fold, sensors are often arranged in this area, which perform the monitoring that a spread according to predetermined criteria is present, and if this is not the case, corrective action is taken in the further course of the translation, and if such remedy is not possible, the respective book block is initially rejected for quality reasons, but in most cases, such a procedure will not arise since, according to the present disclosure, the system includes measures which an increase in the spread can be carried out on the way to the front cut location (see explanations under f) and FIG. 16).

By means of a further translation 503, the book block is transported, with the given spread of the jaw fold or of the cover, to the front cut location, further guides 510 being provided downstream of opening sword 530, which further guides are composed of convex or quasi-convex channels and/or guide plates, which ensure that the spread created by the opening sword is at least maintained in the further course of the transport, or said guides are configured in such a way, that the degree of spread is increased as required up to the front cut location, air jet injectors also acting along these guides 510, which air jet injectors may contribute to a stabilizing, lasting guidance of the spread jaw fold or of the spread cover.

The pressing of the book block body in the region of the front cut is accomplished by at least a portion of the pressing strips 200¹⁻ⁿ shown in FIGS. 8 through 10. While, because of space limitations, only some of these come into action above the spread jaw fold or the spread cover, at least one pressing bar 144 acts below the spread, exerting the ultimate pressure on the book block body, whereby the cutting device encounters clean cutting condition. The other sequences of the pressing strips on both sides of the book block are based on the underlying dynamics according to FIGS. 8 through 10 also in the case of a cutting operation with a jaw fold or cover. This also applies with respect to the operatively connected cutting device, particularly if provision is made for a separation of the operational pressing forces between the pressing bar and the cutting device.

That the spread produced is designed such that after the front cut has been made, a 100 percent shape reversibility occurs such that the original configuration of the jaw fold and cover is restored intact.

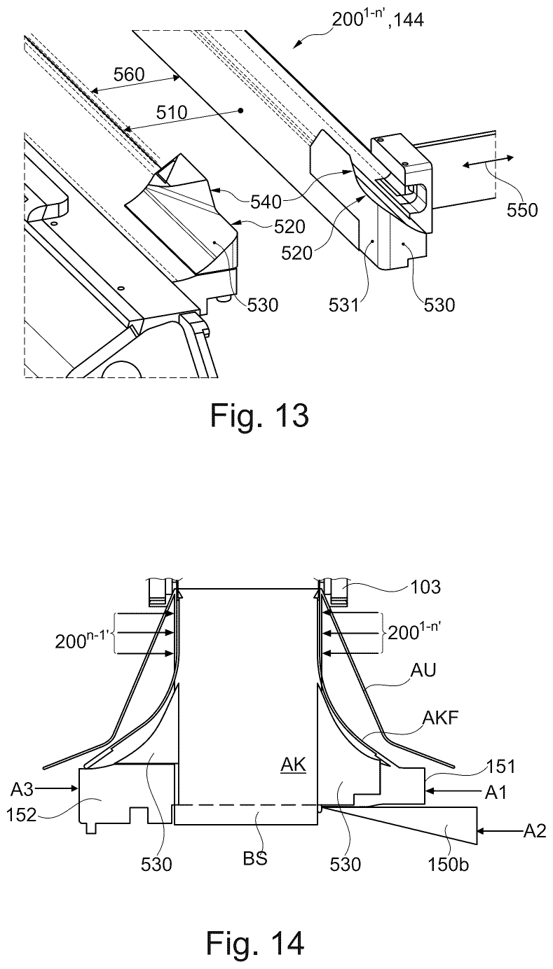

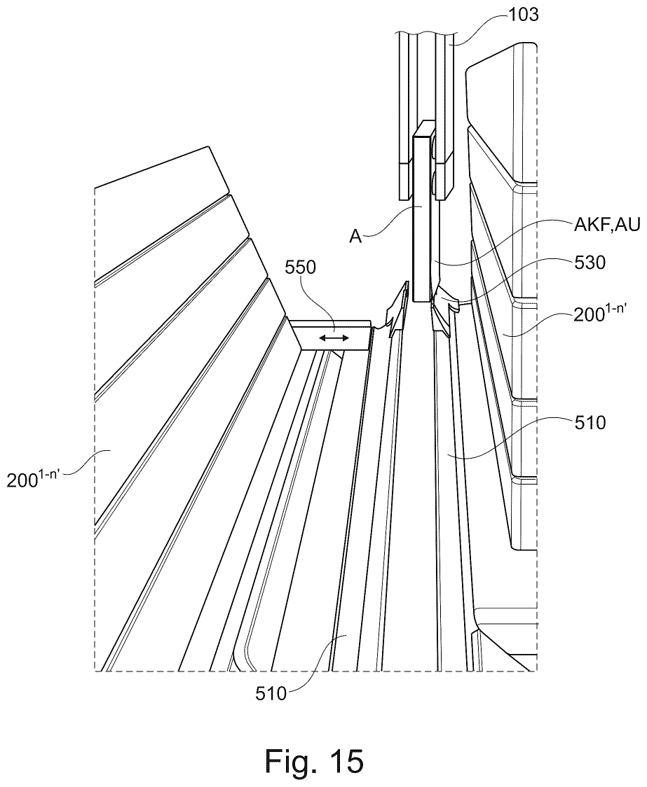

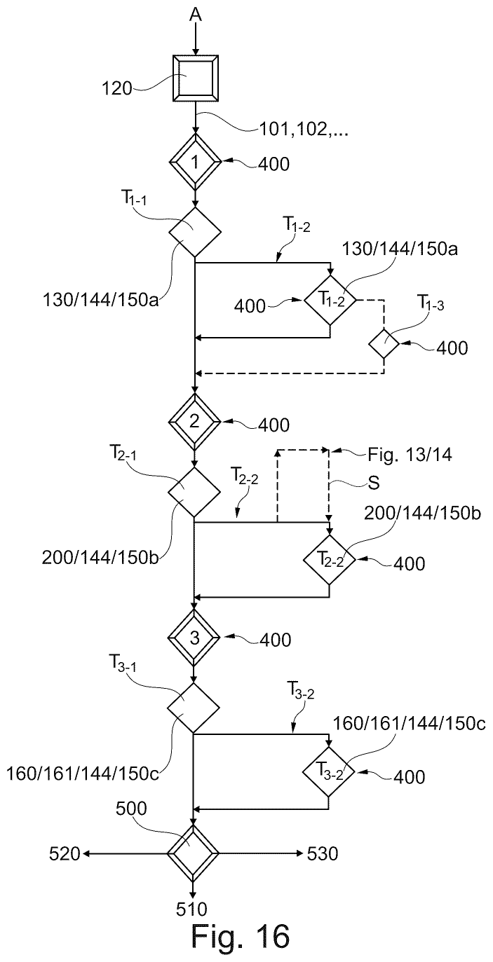

FIG. 13 shows the essential aspects concerning the implementation of the spreading with regard to jaw fold AKF or cover AU (see FIGS. 11 and 14). These are the elements from E1 and E2, (see FIGS. 12) which are here figuratively covered in the transport direction to the front cut location. As can be seen in detail from this FIG. 13, the oppositely disposed opening swords 530 form a spacing 560 relative to each other, the distance of which ensures unhindered passage of the transported book block, it being possible for this spacing to be varied by advancement unit 550 according to the respective thickness of the book block, approximately 5% of the measured thickness being added to the distance in each case to ensure reliable passage of the book block, bearing in mind the fact that the book block is not always present in the form of a compact body.

This per se small amount added to the distance is always necessary when it comes to simultaneously gripping double jaw folds or covers on the book block, i.e., to initiating a spreading on both sides of the book block. In order to vary the spacing 560, the controller-guided advancement unit 550 acts on both elements E1, E2 (see FIG. 12), namely, on the opening swords 530 for creating the causal spread, and on the guides 510 provided downstream for maintaining or increasing this spread. Opposite to the spread jaw fold AKF or to the spread cover AU, the pressing of the book block A or of book block body AK is performed by activating a certain number of pressing strips 200¹⁻ⁿ. In this process, in addition to the pressing strips, pressing bars (see FIGS. 10 and 14, items 152 and 144) also come into action, exerting the ultimate pressure in the region of the cutting operation.

The two opening swords 530 have a substantially vertical surface 531 on the inside of passage 560, which surface 531 extends over the entire length of the sword-like body. This allows book block A to be continuously introduced from below via translation 501 (see FIG. 12), and this kind of feeding can be carried out up to the opening points 521 of the two opening swords 530 (see FIG. 12). Sometimes, it may be provided that the opening blade 540 is formed with a slightly offset lateral portion for initiating the spread of certain book blocks, which slightly offset lateral portion may penetrate more easily between the jaw fold or cover and the book block body.

FIG. 14 shows the condition of the book block to be trimmed by trimming BS immediately prior to the cutting operation at the second cutting location 2 designed for carrying out the front cut. Opening sword 530, as part of element E1 (see FIG. 12), represents the initiation of the spreading of jaw fold AKF or of cover AU, the representation of the spreading in this figure being from a different projection compared thereto, this representation having been included only for the sake of understanding. With regard to the downstream element E2 including the guides 510, reference is made to FIGS. 13 and 15. As far as the pressing of the book block is concerned, this FIG. 14 is essentially based on the operational processes according to FIG. 10. However, a substantial refinement of the subject matter of the present disclosure relates here to the new configuration of the book block with a jaw fold or a cover, where, for reasons of quality preservation, the front cut is only carried out if the opening of the spread includes a sufficiently large margin in order that the jaw fold or cover is not affected by the cutting operation, i.e., not trimmed.

It is obvious that the causally diposed pressing strips 200¹⁻ⁿ according to FIG. 10 are designed for carrying out a front cut of a common book block. However, when there is a jaw fold or a cover, these pressing strips can only be partly applied, i.e., in a sector-wise manner, so that they can act effectively only to the extent permitted by the spread of jaw fold AKF or of cover AU, so the spread jaw fold and cover must not be affected by the cut BS of the book block body AK; i.e., the spread jaw fold and cover must not be damaged by the cutting BS of book block body AK.

As for cover AU, it can further be seen from this FIG. 14 that this cover is shown to have an angled shape, which is intended to represent the state when grippers 103, 104 release the pressure on the book block or swing away, respectively. Accordingly in the present embodiment, it must be ensured that the reduced use of pressing strips 200¹⁻ⁿ come into action only above the line where the spread of jaw fold AKF or of cover AU begins, i.e., strictly speaking, that they act only on the unloaded surfaces of the book block, as is shown in detail in FIG. 14. With such a configuration, it is therefore advantageous if the pressing strips perform an active advancement dynamics on both sides of the book block in order that the lateral free zones are available in a maximized manner for the spreading of the jaw fold or cover. This also applies to the cutting-relevant pressing in the region of the cutting operation by means of cutting device (knife) 150b, pressing bar 151, and the opposite stop 152, which is itself operated by an individual drive A3 in the case of a dynamic advancement.

The pressing force provided by drive A1 at second cutting location 2 for performing the front cut (which also applies to the other cutting locations 1, 3 of the apparatus) for pressing the printed product via pressing bar 151 in a manner suitable for cutting, and the cutting force provided by drive A2 for performing the cutting operation by means of cutting device 150b are accomplished by a common drive unit. Preferably, however, the pressing force provided by drive A1 for the pressing of the printing product in conformity with the cut and the cutting force provided by drive A2 for carrying out the cutting operation should be accomplished by individual drive units. The latter disposition has the advantage that individual adjustments can be made prior to or also continuously during operation.

FIG. 15. shows an overall view of second cutting location 2 up to the front cut location, this figure illustrating how the spreading is carried out for a book block A which is frictionally gripped by gripper 103 (see FIG. 1) and transferred to opening sword 530 as part of first element E1 (see 12), only the spreading a jaw fold AKF or of a cover AU on one side of the book block being concerned here. It is also shown that the arrangements are provided for spreading on both sides. Further shown here is the location at which advancement unit 550 acts to effect the spacing of the opening sword 530 belonging to first element E1 and of the guides 510 belonging to second element E2 (see FIG. 12). As for the operation of these elements E1, E2, reference is made to the explanations given under FIG. 12 instead of many. As for the operation of pressing bars 200¹⁻ⁿ, reference is made to FIGS. 8-10 and 14 instead of many. In other respects, FIG. 15 fully explains itself.

FIG. 16 shows, in the form of a block diagram, the process sequences when carrying out a conventional single cut at each cutting location 1, 2, 3 and those sequences which the implementation of a second, if need be, further subsequently occurring partial cuts. As already partly described above, the introduced printed product A is aligned in infeed wheel 120 for the immediately following cutting operation in such a way that it is gripped by its spine by the first of transport unit 101 for further transport after this this first cutting operation. Generally, the head edge of the printed product is processed at first cutting location 1, but it is not ruled out that this first cutting operation could concern the foot cut. In general, clamping device 130 and pressing bar 144 come into action for this first cutting operation, cutting knife 150a performing the cutting operation. With regard to the sequences occurring within this first cutting location 1, reference is made to the description of the previous figures.

A quality check 400 takes place already with this first cut T₁₋₁ and focuses firstly on the quality of the cut made and, secondly, checks whether the thickness of the cut portion corresponds to the values defined in advance. At the same time, the integrity of the spine of the book block is also checked. The means used for these checks include, firstly, contact-based and contactless sensors, which integrally detect the current state of the printed product (book block, booklet, etc.) after each cutting operation and forward the information derived therefrom to the controller, and, secondly, also newer-generation sensors that ensure sensor-assisted production since they are capable of controlling and optimizing the focused processes for quality. These sensors, in the present embodiment, must have excellent data quality for the here underlying quality checks and are preferably designed on the basis of inductive and photoelectric technologies. In general, the measurand is to be converted into an internal signal by the physical measurement principle of the sensor element. Where necessary, provision is made for further individual electronic processing, whereby a measured value is then available at the output in the form of an electrically and/or electronically usable signal.

If the controller has decided on a second partial cut T₁₋₂ at this first cutting location 1, a process-related repetition of the first cut T₁₋₁, is generally carried out; i.e., the necessary pressing of the printed product is performed by the same means 130 and 144, and the cutting operation is carried out by the same cutting knife 150a. In addition, a coordinated kinematic procedure is also provided, which ensures that the portion to be additionally trimmed off from the head edge of printed product A can then be pushed further with respect to the fixed cutting knife 150a.

Thus, once the first partial cut T₁₋₁ has been made, book block A is briefly clamped by the clamping jaws of the gripper 103 of transport unit 101 of the transport unit, whereupon the clamping jaws 131, 132 belonging to a clamping device 130, also referred to as a transport clamp, open slightly, so that book block A is positioned relative to said clamping jaws 131, 132 in a pressure-free manner. Intermediately, the clamping jaws belonging to gripper 103 of the transport unit 101 of the transport device frictionally lockingly engage book block A at the location where the first partial cut T₁₋₁ was made, which clamping jaws, in operative connection with this transport unit, give book block A an intertemporal local position when the clamping jaws 131, 132 of transport clamp 130 are open. During this interval, the open clamping jaws 131, 132 of transport clamp 130 move rearward relative to cutting knife 150a by a certain length, this length corresponding to the width of second partial cut T₁₋₂. At the end of the traveled length, clamping jaws 131, 132 of transport clamp 130 frictionally lockingly engage book block A again, with the clamping jaws of gripper 103 of the transport unit 101 of the transport unit being opened in a coordinated manner. These clamping jaws 131, 132 of transport clamp 130 now move the clamped printed product A forward by the respective length for the second partial cut T₁₋₂ such that book block A is thus transferred into the cutting position again.

Immediately before the second partial cut T1-2 is started, book block A is pressed by the cutting location-related pressing bar 144, which exerts the ultimate pressing force on the printed product. Once the second partial cut T1-2 is completed, pressing 144 travels back in a manner synchronized with cutting knife 150a, whereupon clamping jaws 131, 132 of transport clamp 130 open, and book block A is then conveyed onward by the transport unit 101 of the transport device. Also during and after the completion of this cutting operation, the quality-checking sensors 400 remain in monitoring mode until these perform the quality check by sensors at the next cutting location, whereby it is ensured that the quality is performed according to the same criteria across all cutting operations. The cutting operations relating to the third cutting location 3 (T₃₋₁, T₃₋₂, etc.) are carried out in a similar way, as can be seen from the block diagram in FIG. 16.

In addition, in the case of a book block provided with a jaw fold or a cover, the following procedure is carried out at second cutting location 2 if the cutting operation is to be performed there over several partial cuts:

The initial spreading of jaw fold (AKF) or of cover (AU) via elements (E1, E2) is carried out from the beginning with an increased opening, so that the subsequent cutting operations can be carried out without interference with the jaw fold or cover, namely as follows: Once the first partial cut T₂₋₁ has been made, book block A is briefly clamped by gripper 103 of transport unit 101, whereupon pressing strips 200¹⁻ⁿ (see FIG. 14) open slightly, such that the block is positioned between the pressing strips in a pressure-free manner. Intermediately, the gripper 103 belonging to support 101 now frictionally lockingly engages the book block at the location of the previously performed first partial cut T₂₋₁, thereby giving it an intertemporal local position when the pressing strips are open. During this interval, transport unit 101 then moves with the book block downward in a guided movement, whose length corresponds to the next partial cut T₂₋₂.

Or, the first partial cut is carried out according to the conventional procedure; i.e., the book block is guided directly to the cutting location where the first partial cut takes place, without a spread being created by elements E1, E2 (see FIG. 13). This is possible because the cutting device operates with a sufficient distance from the end of the jaw fold or of the cover; i.e., without affecting these formations. Moreover, as a result of such operation, all of the pressing strips 200¹⁻ⁿ (see FIG. 10) may come into action. In order to perform a subsequent multiple cut, the book block is then returned to a position before intermediate station E1, E2, whereupon, as described several times above, the spreading of jaw fold (AKF) or of cover (AU) is carried out, thus creating the prerequisites according to the inventive procedure. This return is represented in FIG. 16 by the loop S with the reference to FIGS. 13, 14.

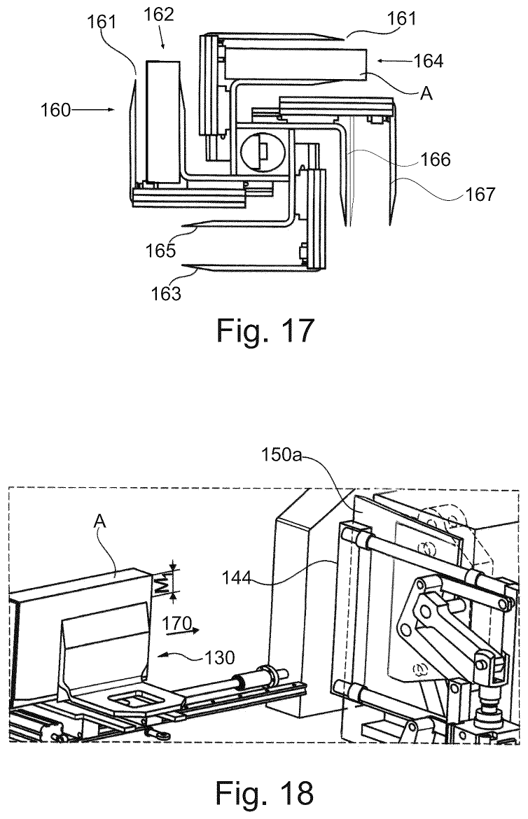

When the cutting operation at the third cutting location 3 (see FIG. 1) is completed, the rotatable outfeed device (four-clamp system) 160, and thus also clamp 161, moves away from the cutting device together with the book block orthogonally to the knife movement. The rotatable four-clamp system 160 rotates by 90° during each cycle (see FIG. 17).

In this context, the four-clamp system 160 shown in FIG. 17 shows the position of clamp 161 in cutting position 162, in which a movable jaw 163 is still open. Another clamp operates within removal position 164. In this position, book block A can be removed. The mode of operation of four-clamp system 160 ensures that, during the cutting process at the third cutting location 3 (see FIGS. 1 and 7) and the rotational movement of the four-clamp system, book block A is strongly pressed between movable jaw 163 and fixed jaw 165. Furthermore, two states of clamp 161 can be seen within one quadrant, namely a completely closed position 166 and a completely open position 167, as can be seen from the intermediately located position. One setting or another within this quadrant may be specifically considered, depending on the respective spatial conditions present during the rotation.

A removal device may be, for example, a conveyor belt equipped with movable rollers for conveying the book block. Other devices known from the prior art may also be provided.

FIG. 18 illustrates the ultimate pressing of the book block by pressing bar 144 during the cutting operation. In terms of effect, such pressing corresponds to that described for FIG. 10. The advance direction is indicated by reference numeral 170.

FIG. 19 illustrates the effect of the various pressing elements (clamping devices) on the printed product, which, with reference to cutting location 2, is exerted by the various clamping devices 103, 200, 144, one clamping device at this cutting location being formed by a pressing strip group 200. The pressing forces illustrated in the diagram within the various clamping devices should merely be understood as a qualitative representation. The clamping force of gripper 103, which is provided for the transport 210 of the printed product from one cutting location to the next, is in itself smaller than the cutting location-related clamping forces 200 and 144, since the force is in this case only one which must be sufficient for the secure clamping effect of the printed product during transport. At cutting location 2, the clamping force of the pressing strips 200¹⁻ⁿ belonging to the pressing strip group then develops simultaneously or subsequently, so that the clamping force of gripper 103 drops 211 immediately (drop point) as soon as the final clamping force of the pressing strip on the printed product is reached. The extent to which the clamping force of the gripper on the book block drops is set individually and also depends on the weight of the respective book block. The final clamping force on the book block, which is important for the cut quality, is then exerted by the previously mentioned pressing bar 144, which assumes its position fully in parallel with the plane of the cutting knife. As can be seen from the force diagram of FIG. 19, the press beam 144 applies its largest clamping force preferably in operative connection with the cutting operation, which clamping force takes place in a variable and phase-shifted manner 212 (intervention plane) with respect to the other clamping devices, as indicated by the parallel broken lines 212a, 212b (phase shift interval). As soon as the pressing force from pressing bar 144 is available, the knife carries out the cutting operation 213. After that, pressing bar 144 remains in cutting plane 215 for a brief period until the clamping force of the gripper has risen to such an extent that reliable further transport 214 of the book block is ensured. Then, the pressing forces of the other elements 144, 200 subsequently decrease according to a particular reduction curve 217, such that the further transport plane 216 containing the printed product that is completely gripped by gripper 103 is open again. In principle, this dynamics also applies to the gripper 104 belonging to second transport unit 102 (see FIG. 1) in operative connection with the clamping devices operating there.

In addition, all pressing elements 103, 104, 144, 200, . . . , operating within the apparatus, whether they act directly or indirectly on the printed product or book block, are supplemented with integrated, hydraulically and/or pneumatically operated additional elements, which serve to assist in the opening and closing of the same. This means that the ordinary mechanisms operating to close and open the pressing elements of the apparatus are permanently or optionally supplemented with further, pneumatically and/or hydraulically operated additional elements, which are able to maximize the acceleration of the respective movement of the pressing elements in both directions, i.e., both during closing and opening, regardless of the frictional locking engagement effected there, the aim here being to achieve a uniform or exponential acceleration. As a result, these accelerations altogether significantly reduce the cycle intervals at the individual cutting stations. This implemented acceleration has a positive effect in particular on the grippers for transporting the printed products, where the plane of force introduction into the printed product for the opening and closing movements differs from the plane of force application in terms of distance, which leads to a system-related, accommodated force exertion.

FIG. 17 further shows symbolically how the mutually coordinated uniform, non-uniform, or adaptive speed and/or movement profile of both pressing elements of a clamping device can also be provided for one-sided exertion of pressing force by pressing bar 144 in that the provision of force for knife 150b is no longer coupled with that for pressing bar 144, and instead the pressing bar exerts its pressing force autonomously on the book block, as symbolized by item 251 (see also FIG. 7). Accordingly, the exertion of pressing force on the printed product by the pressing bar can be provided according to individual criteria. The speed profile of pressing bar 144 can be converted into another mode immediately after the first contact with the book block. This also concerns the force application on the book block itself, which may rise or fall successively in a monotonic manner in accordance with the specifications. Thus, if a certain flexion toward the end of the pressing is desired during the application of force by pressing bar 144, for example, so as not to damage the at most slightly thickened spine part of the book block by pressure marks, this can be achieved by activating a corresponding control profile, in accordance with which, for example, the monotonically increasing force application is implemented in accordance with the charging curve of a capacitor. Accordingly, it is then readily possible to provide an exponential force application, which may come into action intermediately or generally.

Document EP 1 647 373 A1 shall also form an integral part of this description, in particular when it comes to demonstrating how the coordination of the drives for providing the pressing force can be performed in operative connection with the process dynamics in the cutting device and the knife dynamics.

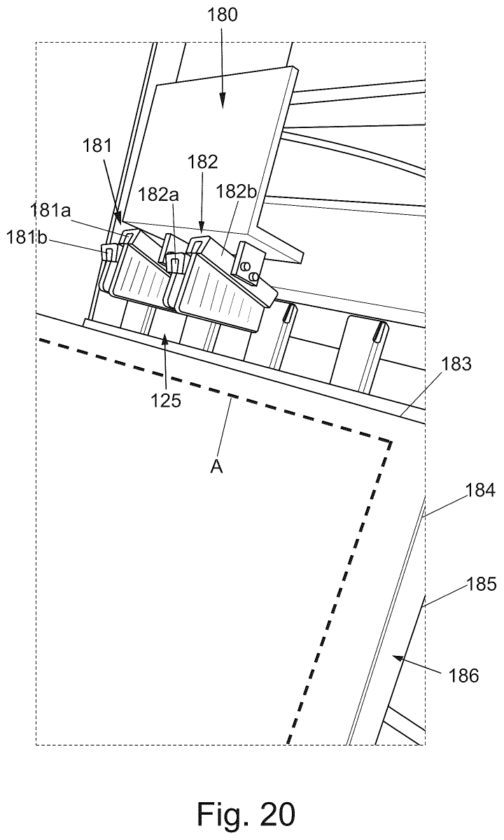

FIG. 20 shows the configuration of a leveler slide 125 (see also FIG. 3). This leveler slide is made up of a receiving plate 180 that acts from above and carries brush bodies 181, 182 on the printed product side, which brush bodies exert a pressure on the front cover ends 183 that protrude beyond printed product A, so that the spine of the printed product is in line with the bearing surface within infeed wheel 120. Since cover ends 184 are located at the front in the same alignment plane, they may be better seen at positions 185 and 186 (head side or foot side of printed product A). The two brush bodies 181 and 182 are cach composed of two sub-brush bodies 181a, 181b, 182a, 182b, which are at such an angle to one another that the respective cover end is gripped in a wedge-like manner and correspondingly pressed downward in parallel, whereby the cover ends do not undergo any damaging arching.

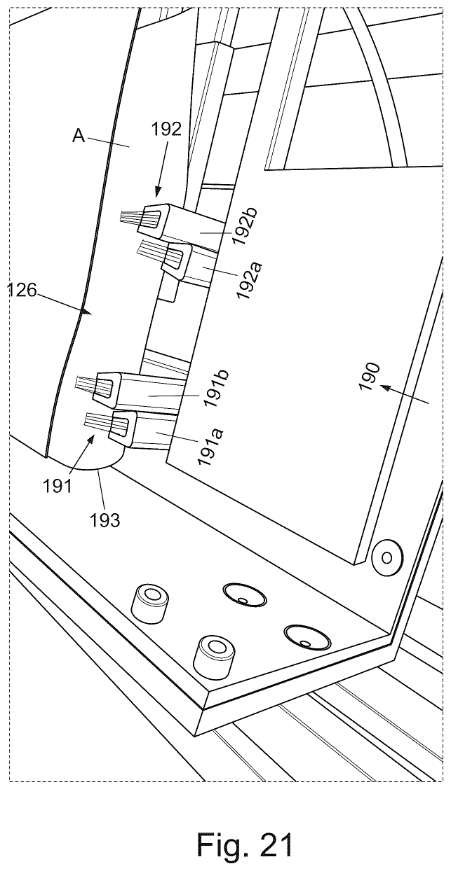

FIG. 21 shows the configuration of another leveler slide 126 (see also FIG. 3). This leveler slide is composed of a receiving plate 190 that acts from a side (head side or foot side) and carries brush bodies 191, 192 on the printed product side, which brush bodies exert a pressure on the head-side or foot-side cover ends 184, 185 that protrude beyond printed product A, so that printed product A is suitably positioned for the cutting operations. Here, the overhanging cover ends are visible in relation to spine part 193 of printed product A. The two brush bodies 191 and 192 are each composed of two sub-brush bodies 191a, 191b, 192a, 192b, which are at such an angle to one another that the respective cover end is gripped in a wedge-like manner by the brush bodies and the entire printed-product body assumes a lateral position so that, again, the cover ends do not undergo any damaging arching.

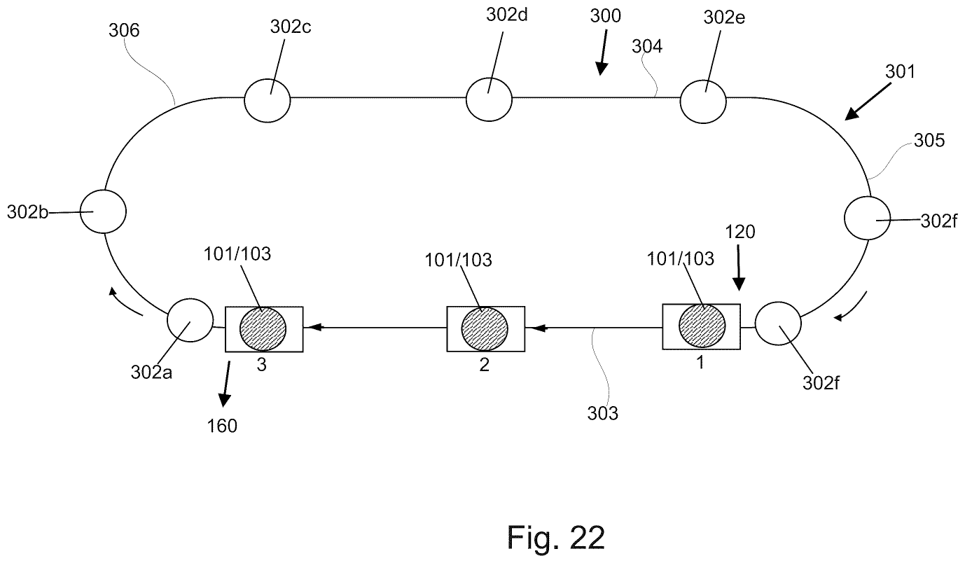

FIG. 22 shows a further transport device 300 for transporting the printed products from one cutting location 1 to the next 2, and from there to a third 3. The cutting operations performed at these cutting locations are the same as those described for FIG. 1.

The main difference compared to the transport dynamics according to FIG. 1 lies here in that at least three transport units with respective grippers 101/103 are in operation along a substantially ellipse-like path 301, this functional endless path being composed of a front section 303 and a rear section 304 running substantially in parallel, the two sections merging into one another by respective returning curvatures 305, 306. The front section is used to guide the transport units 101, which cyclically follow one another, in a straight line or in a quasi-straight line along the cutting locations 1, 2, 3. The number of transport units 101 along the path is dependent on the maximum permissible cycle count; i.e., cach transport unit takes a printed product in a leading manner and guides it successively via the fundamental three cutting locations 1, 2, 3, without handing it over. In order to maximize production, the cycle is designed such that the transport units follow one another closely, and the distance from one another is dependent on the time required for the individual cutting operations, whereby more than three transport units can generally be in operation. A reduction of the number of transport units can be achieved, for example, if they undergo an acceleration along the rear section 304 between the last cutting location 3 and the first cutting location 1.

With such a measure, the intermediate deliveries and take-overs of the printed product specific to the cutting location can be avoided by the transport units moving back and forth (see FIG. 1). On the other hand, a larger number of circulating transport units 302a-302g should generally be provided in order to keep production high, since the transport units need time to travel over the rear section 304.

For a better understanding, the transport units in operation are shown in hatching, whereas the other, unloaded transport units move downstream of the outfeed device 160, i.e., are each on their way to feeding device 120 in order to pick up a new printed product.

A transport variant of this kind characterized by an ellipse-like path 301 can be readily used for central trimming of the printed products, i.e., when the aim is to perform three cutting operations at a single cutting location, and, accordingly, if the printed product is taken, fed to the central cutting location, and then delivered by the same transport unit. Correspondingly, such central trimming may advantageously be performed within the above-described second cutting location 2. Advantageously, the transport units in operation should then not travel back to feeding device 120 over front section 303, but should move on over rear section 304 so as not to inhibit the production flow.

In the case of a central cutting location for trimming all format edges of the printed product, measures should be taken, that the movement of the side knifes and the associated pressing bars have to be designed to be phase-shifted with respect to the movement of the front knife and the associated pressing bar so as to be able to prevent a collision between pressing operations and the dynamics of the cutting devices.

If the printed product is formed with a jaw fold or a cover, opening means are arranged in the region of the front cut for gripping the jaw fold or cover to create a spread, which opening means act without hindering the entire cutting process over all edges of the printed product, in such a way that these opening means either operate from a permanently assigned local position or are intertemporarily activated and deactivated.

The described three-knife trimmer 100 according to the present disclosure has the following advantages over the known three-knife trimmers:

During cutting, the book block is pressed over almost its entire surface area by clamps or pressing strip groups. The book block has a free surface MI only in a region of the book spine, which free surface is used for the gripping of the book block itself. This is per se not critical because the binding holds the book block together sufficiently in this region and the pressing strips support the book block in the cutting region within the respective cutting station of the cutting devices. Pressing the book block over the entire surface area leads to a high cut quality.

The pressing over the entire surface area is achieved in a simple manner. There is no need to move any ribs, supporting elements, or supporting strips according to the format. As a result, a high cycle count and thus high output of the three-knife trimmer may be achieved

Since the book block is transported in a suspended condition to the individual cutting stations 141, 142, 143 (see FIG. 7) by the three-knife trimmer according to the present disclosure, there is no need to take any measures for supporting the pages of the book block at the transfer points in the transport system. Since the book blocks are not transported horizontally, the pages of the book do not sag between the bearing points if the bearing surfaces are not over the entire surface area, as a result of which they cannot become caught at the transfer points.

The three cutting stations 141, 142, 143 of the cutting device are arranged in a U-shape with the open side of the U arranged downward with respect to one another. The portion to be trimmed off from the book block is carried out in all three cutting operations against the inside of the U-shape, in operative connection with pressing beams 144 (see FIG. 7 and, in particular, FIG. 10). As a result, it is possible to successfully “convey away” all three trimmed-off portions using a single cut-off removal device arranged therebelow. These cut-offs therefore fall downward due to gravity without using any additional aids, where they can then be easily collected. This suspended transport position proves to be optimal when it comes to spreading the jaw fold or the cover at the second cutting station.

Effective removal of cut-offs, regardless of whether the products are book blocks or booklets, is therefore very important because in industrial production of individual books, the different formats are very often only produced at the three-knife trimmer. In the process, the book blocks and their protective covers are preferably tailored toward the largest final format, which naturally leads to large trimmings in the case of small final formats.

In three-knife trimmers having cutting cassettes and pressing pads, it is common to align the printed product in the corners between the book spine and the head side and between the book spine and the foot side by means of two rectangular stops, and from the book block front side by one stop. When producing variable-format books, booklets, etc., covers of the same format are often used for a particular format range. If the thickness of the book block now varies and the books are produced by binding machines, these binding machines generally feature powerful fixed-edge processing, and provision may also be made that the cover can be correspondingly matched with respect to the effective book block.

If the dimension of the book block varies, the cover protrudes therefrom to a greater or lesser extent. Generally, the book blocks are produced with a fixed overhang of the cover on one side and a variable overhang on the other side. In the three-knife trimmer according to the present disclosure, the uncut book block or the uncut booklets are aligned at the foot edge or head edge and the processed spine edge. The variable overhangs of the cover in the book block height and the book width are therefore insignificant.

For each book block to be cut or for each booklet to be cut, the three-knife trimmer controller has to know the product data from which the necessary movements of the transport members can be calculated, so that a cut book having the desired format dimensions is ultimately produced. This data can be transmitted to the controller in many different ways.

A few options are set out below by way of example. Each book block or each booklet is equipped with an identification feature. A feature reader at the input of the three-knife trimmer reads the identification feature (e.g., 1-D or 2-D bar code, RFID chip, label, image, etc.) and transmits the information acquired from the identification feature to the controller, which determines the machine cycle assignment. The acquired information may depict, for example, the cut printed product dimensions, or at the same time may identify a missing assignment, whereupon profiles stored in the database may automatically be accessed.

In another system, the book blocks are delivered to the three-knife trimmer in a cyclic manner. With each cycle, the controller of the three-knife trimmer is supplied with the information that is required for cutting the book block to the correct dimension. Here, too, the data supplied with the book block may be matched with the database.

Another option is that the controller is supplied with data that indicates the order of the book blocks delivered. The three-knife trimmer processes the delivered book blocks in the predetermined order, deviations therefrom being simultaneously detected and correspondingly translated into control action. This applies in particular if the equipment is operated entirely according to digitization principles, i.e., if different types of book blocks are to be continuously trimmed also to different dimensions.

When producing covers with a jaw fold, dimensional deviations may occur. As a result, the distance between the front edge of the trimmed book block and the edge of the cover may vary in the finished printed products. It is therefore also conceivable that the covers connected to the book block may be measured with sensors before or in the three-knife trimmer. By measuring the width of the cover, which corresponds to the distance from the spine to the edge of the cover that is parallel to the spine, the book block can be positioned and cut according to the measured cover width during the front cut. The width of the trimmed book block may therefore deviate from the target value stored in the controller, but the cover will protrude the same amount beyond the book block at the front cut or be flush with it in all finished trimmed books.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An apparatus for carrying out cutting operations on format edges of a printed product, the apparatus comprising:
a feeding device in operative connection with a first cutting station, in which at least one first edge-specific cutting operation of the cutting operations is configured to take place;
an outfeed device in operative connection with a last cutting station, in which at least one further edge-specific cutting operation of the cutting operations is configured to take place;
a further cutting station disposed between the first cutting station and the last cutting station, the further cutting station being configured to execute at least one cutting operation of the cutting operations aimed at a front cut of the printed product;
a pressing device in operative connection with a cutting device, and the pressing device being configured to exert at least one pressing force on the printed product, and
a transport unit comprising a gripper configured to provide a frictional locking engagement, the printed product being transportable from one cutting station to the next by the transport unit;
wherein the further cutting station comprises an intermediate station on an input side, the intermediate station being extended with elements configured for creating a spread of a jaw fold belonging to the printed product or of a cover belonging to the printed product,
wherein the intermediate station is configured to accomplish the spreading firstly, by a first translation of the printed product in the transport direction along a contour of a first element of the elements, and, secondly, by a further translation of the printed product in the transport direction along a second element of the elements,
wherein the spread created by the first element is transportable along the second element to a front cut location of the second cutting station, and
wherein the apparatus is configured to perform the front cut on a printed-product body of the printed product where the printed-product body is exposed below the spread.

2. The apparatus as recited in claim 1,
wherein at least the second element is disposed immediately downstream of the first element, and
wherein the second element is configured to maintain or increase the spread of the jaw fold or of the cover created by the first element up to the front cut location.

3. The apparatus as recited in claim 1,
wherein the intermediate station configured for spreading the jaw fold or the cover comprises at least two first and at least two second elements which are disposed opposite each other and spaced apart and which extend in parallel along the second cutting station,
wherein the spacing between the elements is dependent on the thickness of the respective printed product that is passed through,
wherein the spacing between the elements is variable by a mechanical, pneumatic, hydraulic or electric drive, and
wherein the spacing of the elements for achieving a distance in conformity with the printed product can be accomplished by a unilaterally or multilaterally operable drive.

4. The apparatus as recited in claim 1,
wherein the first element is configured as an opening body having substantially the shape of an opening sword, which is substantially composed of an input-side opening edge and a downstream opening blade, the opening blade being configured to first penetrate between the printed-product body and the jaw fold or cover in the course of a second translation, whereby a spreading can be initiated, the opening of which is adjustable in the further course of the translation in such a manner that, due to the thereby formed spread, the front cut can be carried out on the printed-product body.

5. The apparatus as recited in claim 4,
wherein a configuration of the opening body is as follows:
a) the opening body is, in its entirety, made up of an opening sword which, at its beginning, includes an opening edge extending horizontally or quasi-horizontally;
b) the opening sword is further composed of an opening blade, which is disposed downstream of the opening edge in the transport direction, and which penetrates between the printed-product body and the jaw fold or cover in the course of the translation of the printed product;
c) that the spread of the jaw fold or of the cover with respect to the printed-product body, initiated by the formations according to a) and b), can, firstly, be initiated by the penetration of the opening blade into the printed product, and, secondly, the spread is consolidated by the subsequent translation of the printed product over the physical contour of the opening sword.

6. The apparatus as recited in claim 1,
wherein the second element downstream of the first element extends at least until the front cut is carried out at the second cutting station, and
wherein the second element is made up at least of a convexly or quasi-convexly formed, regularly or irregularly extending channel and/or of associated guide plates.

7. The apparatus as recited in claim 1,
wherein a pressing device acting in the cutting station for carrying out the front cut is composed of individual pressing strips, by which a pressing force can be exerted on the two sides of the printed product, which pressing strips are vertically or quasi-vertically arranged and cascaded at least on one side of the printed product,
wherein at least one fixed and/or movable pressing strip exert the pressing forces necessary for the process on the printed product, firstly above the spread itself and, secondly, below the spread on the printed-product body, and
wherein at least one pressing bar is present for the ultimate provision of the pressing force in the region of the cutting operation, which pressing bar is in operative connection with a stop acting in the opposite direction.

8. The apparatus as recited in claim 1,
wherein the feeding device is composed of a rotatable wheel designed in a rake-like manner, by which wheel a printed product initially resting on the spine can be taken, clamps this printed product by frictional locking engagement, and is transferable by a corresponding partial rotation into the position in which, during further transport, the printed product assumes a spine-related suspended position in which at least the first cutting operation can be carried out.

9. The apparatus as recited in claim 1,
wherein the printed product is in a suspended position for carrying out the cutting operations via the cutting station, and the printed product is transportable in this position from one cutting station to the next.

10. The apparatus as recited in claim 1,
wherein the outfeed device is in operative connection with the third cutting station, and this outfeed device is operable according to the following criteria:
a) the outfeed device is operable by a wheel operating in a multi-part manner;
b) the outfeed device has a clamping device composed of at least one first and at least one second jaw, by which jaws a pressing force is exertable on the printed product during the cutting operation taking place at the third cutting station;
c) after the cutting operation at this third cutting station, the multi-part wheel performs a partial rotation, by which the printed product is transferable into a removal position.

11. The apparatus as recited in claim 1,
wherein the cutting location-related pressing device has the form of at least one pressing bar, by which a pressing force can be exerted directly on the printed product or on the printed-product body, and in that the pressing force can be provided by means of a mechanical, pneumatic, hydraulic or electric drive.

12. The apparatus as recited in claims 1,
wherein the provision of the required pressing force acting on the printed product and the provision of the required cutting force for carrying out the cutting operation at the respective cutting station can be implemented by one and the same drive.

13. The apparatus as recited in claims 1,
wherein the provision of the required pressing force acting on the printed product and the provision of the required cutting force for carrying out the cutting operation at the respective cutting station can be implemented by individual drives.

14. The apparatus as recited in claim 1,
wherein the printed product to be trimmed is composed of at least one bound book block, of individual booklets, or of a number of stacked book blocks and/or booklets.

15. The apparatus as recited in claim 1,
wherein the cutting operations that can be carried out on the printed product are controllable in such a way that the same or variable format dimensions with the same or different thicknesses can be continuously produced in a cycle-compliant manner until the point where an individual printed product is discharged.

16. The apparatus as recited in claim 1,
wherein the first edge to be trimmed at the first cutting station concerns the head part, the second edge to be trimmed at the second cutting station concerns the front part, and the third edge to be trimmed at the third cutting station concerns the foot part of the printed product, or in that the first edge to be trimmed at the first cutting station concerns the foot part, the second edge to be trimmed at the second cutting station concerns the front part, and the third edge to be trimmed at the third cutting station concerns the head part of the printed product.

17. The apparatus as recited in claim 1, wherein the pressing elements or clamping devices of the apparatus are equipped with optional, hydraulically and/or pneumatically operable additional elements, in that the additional elements are installed and operatively act in such a manner that they impose a uniform or exponential acceleration on the pressing elements or clamping devices, at least while maintaining the initial pressing force for accomplishing the required frictional locking engagement on the printed product, on the movements imposed by these pressing elements or clamping devices on the printed product, both during the opening and the closing process.

18. A method for operating an apparatus for carrying out cutting operations on format edges of a printed product, the apparatus comprising: a feeding device in operative connection with a first cutting station, in which a first edge-specific cutting operation takes place; an outfeed device in operative connection with a last cutting station, in which a further edge-specific cutting operation takes place; at least one further cutting station that is disposed between the first cutting station and the last cutting station, in the further cutting station at least one cutting operation aimed at a front cut of the printed product takes place, a pressing device in operative connection with a cutting device, the pressing device being configured to exerted a pressing force on the printed product; and a transport unit comprising a gripper, the printed product being passed through by the transport unit, the gripper being effective to provide a frictional locking engagement for transport from one cutting station to the next, the further cutting station being operable for carrying out the front cut and comprising an intermediate station on the input side, the intermediate station being equipped with at least one element for creating a spread of a jaw fold belonging to the printed product or of a cover belonging to the printed product, the spreading being accomplished by at least one translation of the printed product along the contour of a first element, the method comprising:
performing a front cut-specific cutting operation on an exposed printed-product body of the printed product immediately at the location of creation of the spread.

19. A method for operating an apparatus for carrying out cutting operations on format edges of a printed product, the apparatus comprising a feeding device in operative connection with a first cutting station, in which at least one first edge-specific cutting operation takes place; an outfeed device in operative connection with a last cutting station, in which at least one second edge-specific cutting operation takes place; a further cutting station disposed between the first and the last cutting stations, in the further cutting station at least one cutting operation aimed at the front cut of the printed product takes place; a pressing device in operative connection with a cutting device, at least one pressing force is exerted on the printed product, a transport unit comprising a gripper effective to provide a frictional locking engagement for transport from one cutting station to the next, the further cutting station operable for carrying out the front cut has an intermediate station on the input side, the intermediate station being equipped with elements for creating a spread of a jaw fold belonging to the printed product or of a cover belonging to the printed product, the method comprising:
accomplishing the spreading, firstly, by a first translation of the printed product in a transport direction along a contour of a first element of the elements, and, secondly, by a further translation of the printed product in the transport direction along a second element of the elements, the spread created by the first element being led along the second element to a front cut location along the second cutting station, and
performing the front cut on a printed-product body of the printed product where the printed-product body is exposed below the spread.

20. The method as recited in claim 19,
wherein the spreading of the jaw fold or of the cover is carried out as follows:
a) by a first translation, the printed product is conveyed from the first cutting station to a first element of the intermediate station, that the first element is essentially formed by an opening body having the shape of an opening sword and designed for creating a spread, that the printed product is passed over an opening edge to an opening point disposed at the end thereof, which merges into an opening blade in the transport direction;
b) by a further, subsequently occurring translation, the printed product is passed over the contour of the entire opening body such that, in a first step, the opening blade spreadingly penetrates between the jaw fold or cover and the printed-product body, thereby causing the spread between the parts of the printed product;
c) by continuing the translation according to b), the printed product is passed over the further contour of the opening body, thus consolidating the degree of spread of the jaw fold or of the cover with respect to the printed-product body, that the spread thus achieved satisfies the prerequisite for the front cut to be carried out without cutting-operational interferences with the jaw fold or cover;
e) once the transport of the printed product over the opening body is completed, the printed product is conveyed with the previously created spread to the front cut location by a further translation, this spread being in operative connection with the second element belonging to the intermediate station during the further transfer to the front cut location, the original spread being at least maintained or increased along the second element;
wherein the second element is made up at least of convexly or quasi-convexly formed, regularly or irregularly extending channels and/or of associated guide plates, and
wherein the spread produced is designed such that after the front cut has been made, a 100 percent shape reversibility occurs, by which the original configuration of the jaw fold and cover is restored.

21. The method as recited in claim 19,
wherein for the spreading of the jaw fold or of the cover, the first and second elements within the intermediate station are present at least in pairs in such a manner that they are disposed opposite each other on each side of the passage and extend in parallel along the intermediate station up to the front cut location in the second cutting station,
wherein the spacing between the elements, which is dependent on the passage, in each case corresponds the thickness of the respective printed product that is passed through, in that the adjustable spacing between the elements is produced by a mechanical, pneumatic, hydraulic or electric drive, and in that the drive is coupled to the first and/or second element in order to implement the spacing.

22. The method as recited in claim 19,
wherein the printed product introduced by the translation, during its passage through the first element for carrying out the spreading of the jaw fold or of the cover, is there intertemporarily stopped or transported through, in that in either case, the initiated and/or continued spreading is assisted by at least one air jet.

23. The method as recited in claim 19,
wherein the degree of the spread of the jaw fold or of the cover, which is created in the first element, is maintained or increased by the configuration of the second element up to the front cut location.

24. The method as recited in claim 19,
wherein, by the pressing device acting in the cutting station, a resulting pressing force is exerted on the printed product on both sides thereof,
wherein the pressing device is composed, at least on one side of the printed product, of individual vertically or quasi-vertically arranged pressing strips, whose number come into action in a coordinated manner above the spread during the front cut,
wherein the pressing force required directly or indirectly for the front cut is in operative connection with the printed-product body below the spread, and
wherein the pressing force is exerted by at least one fixed and/or movable pressing bar.

25. The method as recited in claim 19,
wherein the feeding device is composed of a rotatable wheel designed in a rake-like manner, which wheel grips a printed product initially resting on the spine, clamps it by the action of a force, and transfers it by a corresponding partial rotation into the position in which the printed product has a spine-related suspended position for further transport, in which position the first cutting operation is carried out, whereupon the printed product, while still in the suspended position, is taken by a transport unit and transferred to the next cutting stations for carrying out further cutting operations.

26. The method as recited in claim 19,
wherein the outfeed device operates in operative connection with the third cutting station, which is operated according to the following criteria:
a) the outfeed device is operated by a wheel operating in a multi-part manner;
b) the outfeed device has a clamping device composed of at least one first and at least one second jaw, by which jaws, a printed product-related pressing force is exerted during the cutting operation;
c) after the cutting operation at the third cutting location, the multi-part wheel performs a partial rotation, by which the printed product is transferred into a removal position.

27. The method as recited in claim 19,
wherein the apparatus comprises at least two transport units, each having one gripper, the grippers configured to frictionally grip the spine of the printed product to be trimmed, the two transport units being in operative connection with one another, and the transport units being operated in relation to the cutting stations by the following controller-assisted translational movements along a guide path:
a) the gripper of the first transport unit frictionally grips the printed product immediately after the cutting operation at the first cutting station is completed;
b) the first transport unit then conveys the frictionally gripped printed product to the second cutting station, which printed product is positioned there for carrying out the second cutting operation, and this first transport unit then returns empty to the first cutting station, where a newly delivered, already trimmed printed product is picked up;
c) in the meantime, the gripper of the second transport unit takes the printed product immediately after the cutting operation at the second cutting location is completed, and transfers it to the third cutting location, where the third cutting operation carried out, whereupon the printed product is fed out; and
d) after that, the second transport unit returns empty to the second cutting station, where a newly delivered, already trimmed printed product is present, whereupon this printed product is frictionally gripped by the gripper of the second transport unit and transferred to the third cutting station, in which the third cutting operation occurs.

28. The method as recited in claim 19,
wherein at each cutting station, the following pressing forces are exerted on the printed product before, during, and after the respective cutting operation:
a) one pressing force is exerted on the printed product by the clamping jaws belonging to the gripper, which pressing force is rated for frictionally locking transport of the printed product from one cutting station to the next;
b) another pressing force is exerted on the printed product by at least one first pressing device acting at each cutting station, which pressing force is stationarily exerted on the printed product in the region of the respective cutting operation; and
c) a further pressing force is exerted on the printed product by at least one second pressing device taking place at each cutting station, whose pressing force is applied directly in the region of the respective cutting operation.

29. The method as recited in claim 28,
wherein the exertion of the pressing force for accomplishing the required frictional locking engagement on the printed product is supplemented with means that additionally impose a uniform or exponential acceleration on the respective movement.

30. A method for operating an apparatus for carrying out cutting operations on format edges of at least one printed product, the apparatus comprises: a feeding device by which the printed product is provided for further transport; an outfeed device present after a last performed cutting operation, which outfeed device performs a removal of a trimmed printed product; a plurality of transport units, which are guided in a cycle-compliant manner along a closed, endless guide path, each transport unit being individually loaded with at least one printed product, which is conveyed by the same transport unit from one cutting station to the next, after the last cutting station and upon delivery of the trimmed product, each transport unit being returned unloaded via a closed, endless guide path to the first cutting station so as to receive a newly delivered printed product, the cutting station operable for carrying out the front cut has an intermediate station on the input side, the intermediate station being equipped with elements for creating a spread of a jaw fold belonging to the printed product or of a cover belonging to the printed product, the method comprising:
accomplishing the spreading, in a first step, by a first translation of the printed product in a transport direction along a contour of a first element of the elements, and, in a second step, by a further translation of the printed product in the transport direction along a second element of the elements, the spread created by the first element being transported along the second element to a front cut location of the second cutting station, and
performing the front cut on a printed-product body of the printed product where the printed-product body is exposed below the spread.

31. A method for operating an apparatus for performing cutting operations on format edges of at least one printed product, the apparatus comprising a delivery device configured to provide the printed product for further transport; an outfeed device present after a last performed cutting operation, the outfeed device performing a removal of a trimmed printed; a transport unit, the method comprising:
guiding the transport unit in a cycle-compliant manner along a closed or open guide path, the transport unit being individually loaded with at least one printed product, which is transferred directly to a central cutting station, in which all cutting operations are performed on the printed product in such a manner that the individual kinematics sequences of pressing elements and of the cutting devices are coordinated in such a way that they are carried out by non-colliding cutting processes.

32. The method as recited in claim 31,
wherein the printed product is extended with a jaw fold or cover, which is safeguarded during the execution of the front cut by means of a created spread of the same, in that the implementation of this spread is carried out by at least one opening element directly in the region of the central cutting station, in that by intertemporarily activating or deactivating at least one opening element, the unhindered execution of the other cutting operations is carried out at this central cutting station.

33. The method as recited in claim 30,
wherein the generated pressing force on the printed product and the provision of the respective cutting force required for carrying out the local cutting operation are provided by one and the same drive.

34. The method as recited in claim 30,
wherein the generated pressing force on the printed product and the provision of the respective cutting force required for carrying out the local cutting operation are provided by individual drives.

35. A method for operating an apparatus for carrying out cutting operations on format edges of at least one printed product, the apparatus comprising a feeding device in operative connection with a first cutting station, in which at least one first edge-specific cutting operation takes place; an outfeed device in operative connection with a last cutting station, in which at least one second edge-specific cutting operation takes place; a further cutting station disposed between the first and the last cutting station, in which at least one cutting operation aimed at a front cut of the printed product takes place, a pressing device in operative connection with a cutting device, the pressing device exerting at least one pressing force on the printed product; a transport unit for transporting the printed product from one cutting station to the next, transport unit having a gripper effective to achieve a frictional locking engagement, the further cutting station for the front cut comprising an intermediate station on an input side, the intermediate station being equipped with elements for creating a spread of a jaw fold belonging to the printed product or of a cover belonging to the printed product, the method comprising:
using the elements to initiate, create, maintain, or increase the spread of the jaw fold or of the cover, such initiation, creation, maintenance, or increase of the spread being accomplished by the following:
a) by a first translation, the printed product is conveyed from the first cutting station to a first element within the second cutting station, which element essentially has the form of an opening body designed for creating a spread, the printed product being passed over an opening edge belonging to the opening body to an opening point disposed at the end thereof, the opening point merging into an opening blade;
b) by a further, subsequently occurring translation, the printed product is passed over the contour of the entire opening body in such a way that, in a first step, the opening blade belonging to the opening body spreadingly penetrates into the space between the jaw fold or cover and the printed-product body, thereby initiating the spreading;
c) by continuing the translation under b), the printed product is passed over the further contour of the opening body, whereby the degree of spread of the jaw fold or of the cover with respect to the printed-product body experiences a consolidation, the spread thus achieved having an opening through which a trimming of the front cut is carried out without interference with the jaw fold or cover; and
d) once the translation over the opening body is completed, the printed product is conveyed with the previously created spread via a second element to the front cut location by means of a further translation, the opening of the spread being at least maintained or increased during this transfer
wherein the spread produced is designed such that after the front cut has been made, a one-hundred percent shape reversibility occurs, by which the original configuration of the jaw fold and cover is restored.

36. The method as recited in claim 35,
wherein the initiation and continuation of the spread of the jaw fold or of the cover in the region of the opening body belonging to the first element is assisted by at least one air jet.

37. The method as recited in claim 35,
wherein the configuration of the second element along the cutting station is made up of a convex or quasi-convex guide, which guide is configured such that the given spread of the jaw fold or of the cover from the first element is maintained or increased in the course of a further translation toward the front cut location.

38. The method as recited in claim 37,
wherein the guide belonging to the second element has the shape of a regularly or irregularly extending channel and/or with associated guide plates, which are used as required to support the spread ends of the jaw fold and the cover.

39. The method as recited in claim 35,
wherein along the guides belonging to the second element, the spread is acted upon by at least one further air jet to maintain or increase the given opening.

40. The method as recited in claim 35,
wherein local sensors operate to assure the quality of the spread of the jaw fold or of the cover, the sensors monitoring the required characteristics of the spread until the front cut is completed.

41. The method as recited in claim 35,
wherein the pressing of the printed product in the region of the front cut is accomplished by at least a portion of the pressing strips 200¹⁻ⁿ operating at this cutting station, the activation of these pressing strips being coordinated in such a manner they are applied in the region above the spread jaw fold or the cover, in that below the jaw fold or the cover, the pressing of the printed-product body is accomplished by movable or fixed pressing bars, which perform the ultimate pressing of the printed-product body for the execution of the front cut, in that the pressing forces or cutting forces introduced into pressing bars and the cutting device are produced by a single drive or separate drives.

42. A method for operating an apparatus for carrying out cutting operations on format edges of a printed product, the apparatus comprising: a feeding device in operative connection with a first cutting station, in which at least one first edge-specific cutting operation takes place; am outfeed device in operative connection with a last cutting station, in which at least one second edge-specific cutting operation takes place; a further cutting station disposed between the first and the last cutting station, in which further cutting station at least one cutting operation aimed at a front cut of the printed product takes place, a pressing device, which is used in each of the cutting operations, by which pressing device at least one pressing force is exerted on the printed product to act thereon, at least one transport unit transporting the printed product from one cutting station to the next, the transport unit having a gripper effective to provide a frictional locking engagement, the further cutting station operable for carrying out the front cut comprising an intermediate station on an input side, the intermediate station is equipped with elements for creating a spread of a jaw fold belonging to the printed product or of a cover belonging to the printed product, the method comprising:
accomplishing the spreading, firstly, by a first translation of the printed product in a transport direction along a contour of a first element, and, secondly, by a second translation of the printed product in a transport direction along a contour of the second element, a degree of opening of the spread being maintained or increased along the second element, performing the front cut on an exposed printed-product body at the end of the second element, and
during a subsequent multiple cut, initially increasing the initial spread of the jaw fold or of the cover to such an extent that several free cutting operations take place one after the other at the same cutting station.

43. A method for operating an apparatus for carrying out cutting operations on format edges of at least one printed product, the apparatus comprising: a feeding device in operative connection with a first cutting station, in which at least one first edge-specific cutting operation takes place; an outfeed device in operative connection with a last cutting station, in which at least one second edge-specific cutting operation takes place; a further cutting station disposed between the first and the last cutting station, in which further cutting station at least one cutting operation aimed at the front cut of the printed product takes place; at least one pressing device for carrying out the cutting operations, by which pressing device at least one pressing force is exerted on the printed product to act thereon; at least one transport unit transporting the printed product from one cutting station to the next, the transport unit comprising a gripper effective to provide a frictional locking engagement, the further cutting station operable for carrying out the front cut comprising an intermediate station on an input side, which intermediate station is equipped with elements for creating a spread of a jaw fold belonging to the printed product or of a cover belonging to the printed product, the method comprising:
accomplishing the spreading, firstly, by a first translation of the printed product in the transport direction along a contour of a first element, and, secondly, by a second translation of the printed product in the transport direction along a contour of the second element, the degree of opening of the spread being maintained or increased along the second element, performing the front cut on a now exposed printed-product body at an end of the second element, and
during a subsequent multiple cut, a first cutting operation is carried out directly without initiating a spread, whereupon the printed product is returned to the intermediate station, in which the spread of the jaw fold or of the cover is provided for at least one subsequent cutting operation through the use of the mentioned elements.
